(19) United States
(12) Patent Application Publication
(10) Pub. No.: US 2025/0260039 A1
(43) Pub. Date: Aug. 14, 2025

(54) METHODS OF IMPROVING AN INTERFACE BETWEEN AN ELECTRODE AND AN ELECTROLYTE OF AN ELECTROCHEMICAL CELL, AND RELATED APPARATUSES, AND SYSTEMS

(71) Applicant: Battelle Energy Alliance, LLC, Idaho Falls, ID (US)

(72) Inventors: Dong Ding, Idaho Falls, ID (US); Wenjuan Bian, Ammon, ID (US); Wei Wu, Idaho Falls, ID (US)

(21) Appl. No.: 18/726,025

(22) PCT Filed: Jan. 10, 2023
(86) PCT No.: PCT/US2023/060386

§ 371 Date: Jul. 1, 2024

Related U.S. Application Data
(60) Provisional application No. 63/298,084, filed on Jan. 10, 2022.

(51) Int. Cl. H01M 8/1246; C25B 9/23; C25B 11/042; C25B 13/07; H01M 4/90; H01M 8/12; H01M 8/1213

(52) U.S. Cl. CPC H01M 8/1246; C25B 9/23; C25B 11/042; C25B 13/07; H01M 4/9033; H01M 8/1213; H01M 2008/1293

(57) ABSTRACT

A method of improving an interface between an electrode and an electrolyte of an electrochemical cell is disclosed. The method includes forming an electrolyte material on an electrode of an electrochemical cell. The electrolyte may include a perovskite material. The electrolyte material may be exposed to one or more of an acid solution, a plasma, thermal shock, and gamma radiation to increase the surface roughness of the electrolyte material. Additional methods, electrochemical cells, and systems are disclosed.

### CROSS-REFERENCE TO RELATED APPLICATIONS

This application is a national phase entry under 35 U.S.C. § 371 of International Patent Application PCT/US2023/060386, filed Jan. 10, 2023, designating the United States of America and published as International Patent Publication WO2023/133587 A2 on Jul. 13, 2023, which claims the benefit under Article 8 of the Patent Cooperation Treaty to U.S. Patent Application Ser. No. 63/298,084, filed Jan. 10, 2022.

### RESEARCH OR DEVELOPMENT

This invention was made with government support under Contract No. DE AC07 05-ID14517 awarded by the United States Department of Energy. The government has certain rights in the invention.

### TECHNICAL FIELD

Embodiments of the disclosure generally relate to electrochemical cells (e.g., fuel cells, electrolysis cells). In particular, embodiments of the disclosure relate to surface treatments for electrolytes in the electrochemical cells (e.g., fuel cells, electrolysis cells).

### BACKGROUND

Protonic ceramic electrochemical cells (e.g., proton ceramic fuel cells (PCFCs), proton ceramic electrolysis cells (PCECs)) are promising for fuel and hydrogen (H₂) production and power generation at intermediate temperatures (e.g., temperatures within a range of from about 400° C. to about 600° C.). Conventional PCFCs/PCECs include a perovskite-structure oxide electrolyte (e.g., a yttrium- and ytterbium-doped barium-zirconate-cerate (BZCYYb), a yttrium-doped barium-zirconate (BZY)). The conventional perovskite-structure oxide electrolytes exhibit a high bulk proton conductivity that enables lower temperature operations than those for oxygen ion conductor-based solid oxide fuel/electrolysis cells (SOFCs/SOECs) due to smaller activation energy. However, there remain electrolyte-related challenges that limit PCFC/PCEC applications.

Even though the electrolyte exhibits high proton conductivity (e.g., greater than 10 mS cm⁻¹ at 500° C.), an observed ohmic loss in the electrochemical cells is much larger than a theoretical value estimated from bulk proton conductivity alone, and observed bulk proton conductivity in the electrochemical cell is much lower than a theoretical value bulk proton conductivity. In addition, an interface between an oxygen electrode and the electrolyte of the electrochemical cells is mechanically weak, which causes delamination and other forms of degradation, resulting in poor electrochemical performance of the electrochemical cell, especially under high-current-density PCEC operation conditions.

### BRIEF SUMMARY

This summary does not identify key features or essential features of the claimed subject matter, nor does it limit the scope of the claimed subject matter.

Accordingly, in some embodiments, a method of improving an interface between an electrode and an electrolyte of an electrochemical cell is disclosed. The method comprises forming an electrolyte material on an electrode of an electrochemical cell. The electrolyte comprises a perovskite material. The electrolyte material is exposed to one or more of an acid solution, a plasma, thermal shock, and gamma radiation to increase a surface roughness of the electrolyte material.

Accordingly, in some embodiments, a method of forming an electrochemical cell is disclosed. The method comprises forming an electrolyte material on a first electrode of an electrochemical cell, the electrolyte material comprising a perovskite material. The electrolyte material is exposed to at least one acid solution to increase a surface roughness of the electrolyte material. After exposing the electrolyte material to the at least one acid solution, a second electrode is formed on the electrolyte material.

Accordingly, in some embodiments, an electrochemical cell is disclosed. The electrochemical cell comprises a first electrode, a second electrode, and a proton-conducting membrane between the first electrode and the second electrode. The proton-conducting membrane comprises a perovskite material. An interface between the proton-conducting membrane and the second electrode exhibits a peeling strength within a range of from about 17 N to about 40 N.

Accordingly, in some embodiments, a system for H₂ gas production and electricity generation is disclosed. The system comprises at least one steam source, at least one electrochemical apparatus in fluid communication with the at least one steam source, and a power source electrically connected to the at least one electrochemical apparatus. The at least one electrochemical apparatus comprises one or more electrochemical cells.

### BRIEF DESCRIPTION OF THE DRAWINGS

The illustrations presented in this disclosure are not meant to be actual views of any particular electrochemical cell or component thereof, but are merely idealized representations employed to describe illustrative embodiments. Thus, the drawings are not necessarily to scale.

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a simplified cross-sectional view of an electrochemical cell, according to embodiments of the disclosure;

FIG. 2 is a simplified cross-sectional view that illustrates a method of forming the electrochemical cell 100 of FIG. 1, according to embodiments of the disclosure;

FIG. 3 is a simplified schematic view of a system for H₂ gas production and electricity generation including the electrochemical cell of FIG. 1, according to embodiments of the disclosure;

FIG. 4 includes atomic force microscopy (AFM) scans of untreated and treated electrolyte surfaces, as described in Example 2;

FIG. 5A is a graphical representation of results associated with electron impedance spectroscopy (EIS) measurements, as described in Example 4;

FIG. 5B is a graphical representation of an Arrhenius plot of ohmic resistance associated with the EIS measurements of FIG. 5A, as described in Example 4;

FIG. 5C is a graphical representation of an Arrhenius plot of polarization resistance associated with the EIS measurements of FIG. 5A, as described in Example 4;

FIG. 5D is a graphical representation of calculated activation energies associated with the EIS measurements of FIG. 5A, as described in Example 4;

FIG. 5E is a graphical representation of a correlation between enhanced kinetics associated with the EIS measurements of FIG. 5A, as described in Example 4;

FIG. 5F is a graphical representation of an Arrhenius plot correlating a relative “resistance” and the inverse of a reduced temperature associated with the EIS measurements of FIG. 5A, as described in Example 4;

FIG. 6 is a graphical representation showing current density results (e.g., polarization curves) of electrochemical cells operated as electrolysis cells, as described in Example 5;

FIG. 7A is a graphical representation showing Faradic efficiency of electrochemical cells operated as electrolysis cells, as described in Example 5;

FIG. 7B is a graphical representation showing hydrogen production rate of electrochemical cells operated as electrolysis cells, as described in Example 5;

FIG. 8 is a graphical representation showing current density results (e.g., polarization curves) and power density results of electrochemical cells operated as fuel cells, as described in Example 5;

FIG. 9 is a graphical representation showing degradation results of electrochemical cells continuously operated as electrolysis cells for 200 hours, as described in Example 6;

FIG. 10A is a graphical representation showing voltage and power density curves for an untreated electrochemical cell and a treated electrochemical cell including an LSCF oxygen electrode, as described in Example 8;

FIG. 10B is a graphical representation showing voltage and power density curves for an untreated electrochemical cell and a treated electrochemical cell including a PBSCF oxygen electrode, as described in Example 8;

FIG. 10C is a graphical representation showing voltage and power density curves for an untreated electrochemical cell and a treated electrochemical cell including a PNC55 oxygen electrode, as described in Example 8;

FIG. 10D is a graphical representation showing voltage and power density curves for an untreated electrochemical cell and a treated electrochemical cell including a PNC73 oxygen electrode, as described in Example 8;

FIG. 10E is a graphical representation showing voltage and power density curves for an untreated electrochemical cell and a treated electrochemical cell including a 3D PNC73 mesh oxygen electrode, as described in Example 8;

FIG. 11A is a graphical representation comparing peak power density of untreated electrochemical cells and treated electrochemical cells, as described in Example 8;

FIG. 11B is a graphical representation comparing current density of untreated electrochemical cells and treated electrochemical cells, as described in Example 8;

FIG. 12A is a graphical representation of gas chromatography results for three reference gases (pure H₂, pure air, and an H₂+air mixture), as described in Example 9;

FIG. 12B is a graphical representation of gas chromatography results for an untreated electrochemical cell, as described in Example 9; and

FIG. 12C is a graphical representation of gas chromatography results for a treated electrochemical cell, as described in Example 9.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances, similar structures or components in the various drawings may retain the same or similar numbering for the convenience of the reader; however, the similarity in numbering does not necessarily mean that the structures or components are identical in size, composition, configuration, or any other property.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

As used herein, the term “negative electrode” means and includes an electrode having a relatively lower electrode potential in an electrochemical cell (i.e., lower than the electrode potential in a positive electrode therein). Conversely, as used herein, the term “positive electrode” means and includes an electrode having a relatively higher electrode potential in an electrochemical cell (i.e., higher than the electrode potential in a negative electrode therein).

As used herein, the term “electrolyte” means and includes an ionic conductor, which can be in a solid state, a liquid state, or a gas state (e.g., plasma).

As used herein, the term “compatible” means that a material does not undesirably react, decompose, or absorb another material, and also that the material does not undesirably impair the chemical and/or mechanical properties of the another material.

As used herein, the term “triple conducting perovskite” means and includes a perovskite formulated to conduct hydrogen ions (H⁺) (e.g., protons), oxygen ions (O₂), and electrons (e⁻). A triple conducting perovskite exhibits a cubic lattice structure, with the general formula ABO_{3-δ}, where A consists of one or more lanthanide elements (e.g., lanthanum (La), cerium (Ce), praseodymium (Pr), neodymium (Nd), promethium (Pm), samarium (Sm), europium (Er), gadolinium (Gd), terbium (Tb), dysprosium (Dy), holmium (Ho), erbium (Er), thulium (Tm), ytterbium (Yb), lutetium (Lu)), B consists of cobalt (Co) and one or more of nickel (Ni), manganese (Mn), and iron (Fe), and δ is the oxygen deficit.

As used herein, spatially relative terms, such as “adjacent,” “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, material distribution, orientation, and arrangement of one or more of at least one structure and at least one apparatus facilitating operation of one or more of the structures and the apparatus in a pre-determined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, at least 99.9% met, or even 100.0% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

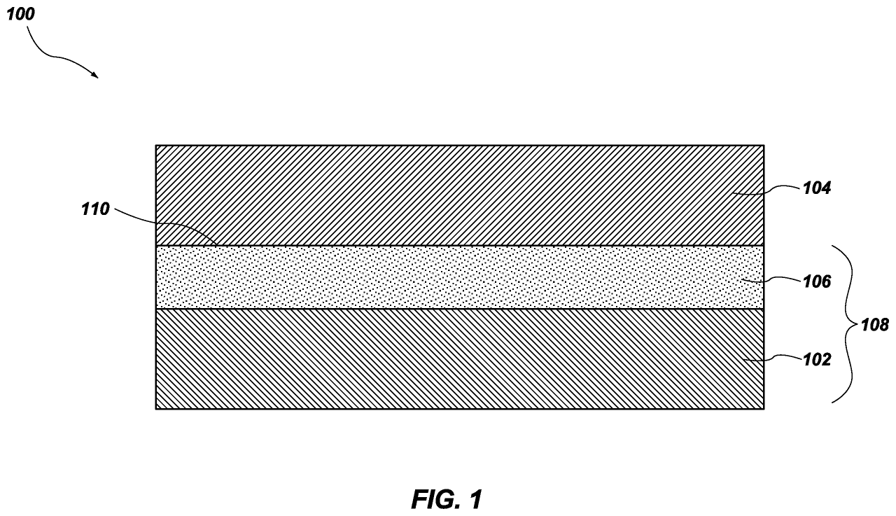

FIG. 1 illustrates a cross-sectional view of an electrochemical cell 100, according to embodiments of this disclosure. As shown in FIG. 1, the electrochemical cell includes a hydrogen electrode 102 (e.g., a H₂ gas side electrode), an oxygen electrode 104 (e.g., a steam side electrode), and an electrolyte 106 (e.g., a proton-conducting electrolyte, a proton-conducting membrane) disposed between the hydrogen electrode 102 and the oxygen electrode 104. The hydrogen electrode 102 and the electrolyte 106 may collectively form a hydrogen electrode-electrolyte bi-layer 108. In some embodiments, the electrochemical cell 100 is a protonic ceramic electrochemical cell. The electrochemical cell 100 may operate as an electrolysis cell to produce H₂ gas from steam or may operate in reverse as a fuel cell to generate electricity from H₂ gas (e.g., at least a portion of the H₂ gas produced when the electrochemical cell 100 is operated as an electrolysis cell). The electrochemical cell 100 may operate at an operational temperature within a range of from about 400° C. to about 600° C. The electrochemical cell 100 may operate at current densities greater than or equal to about 0.1 amperes per square centimeter (A/cm²), such as greater than or equal to about 0.5 A/cm², greater than or equal to about 1.0 A/cm², greater than or equal to about 2.0 A/cm², greater than or equal to about 3.0 A/cm², or greater than equal to about 3.5 A/cm².

The electrolyte 106 may be a proton-conducting membrane. The electrolyte 106 may be formed of and include at least one electrolyte material exhibiting an ionic conductivity (e.g., H⁺ conductivity) greater than or equal to about 10⁻² S/cm, such as within a range of from about 10⁻² S/cm to about 1 S/cm, at one or more temperatures within a range of from about 150° C. to about 650° C., such as from about 200° C. to about 600° C. The electrolyte material may be formulated to remain substantially adhered (e.g., laminated) to the hydrogen electrode 102 and the oxygen electrode 104 at relatively high current densities, such as at current densities greater than or equal to about 0.1 A/cm² (e.g., greater than or equal to about 0.5 A/cm², greater than or equal to about 1.0 A/cm², greater than or equal to about 2.0 A/cm², greater than or equal to about 3.0 A/cm², greater than equal to about 3.5 A/cm²). In some embodiments, the electrolyte 106 is formed of and includes at least one perovskite material having an operational temperature (e.g., a temperature at which the conductivity of the perovskite material is greater than or equal to about 10⁻² S/cm, such as within a range of from about 10⁻² S/cm to about 1 S/cm) within a range of from about 350° C. to about 650° C. The electrolyte 106 may be formed of and include a perovskite material exhibiting a cubic lattice structure with a general formula ABO_{3-δ}, where A may comprise barium (Ba), B may comprise one or more of zirconium (Zr), cerium (Ce), yttrium (Y), and ytterbium (Yb), and δ is the oxygen deficit. By way of non-limiting example, the electrolyte 106 may be formed of and include one or more of a yttrium- and ytterbium-doped barium-zirconate-cerate (BZCYYb), such as BaZr_{0.8-y}Ce_{y} Y_{0.2-x}YbₓO_{3-δ}, where x and y are dopant levels and δ is the oxygen deficit (e.g., BaZr_{0.1}Ce_{0.7}Y_{0.1}Yb_{0.1}O_{3-δ} (BZCYYb1711), BaZr_{0.4}Ce_{0.4}Y_{0.1}Yb_{0.1}O_{3-δ} (BZCYYb4411), BaZr_{0.3}Ce_{0.5}Y_{0.1}Yb_{0.1}O_{3-δ} (BZCYYb3511)), doped barium-zirconate (BaZrO₃) (e.g., yttrium-doped BaZrO₃ (BZY), such as BaZr_{0.8}Y_{0.2}O_{3-δ} where δ is the oxygen deficit), barium-yttrium-stannate (Ba₂(YSn)O_{5.5}), and barium-calcium-niobate (Ba₃(CaNb₂)O₉). In some embodiments, the electrolyte 106 is formed of and includes BZCYYb.

The hydrogen electrode 102 may be formed of and include a material compatible with the material of the electrolyte 106 and a material of the oxygen electrode 104 under the operating conditions (e.g., temperature, pressure, current density) of the electrochemical cell 100. The material composition of the hydrogen electrode 102 may facilitate the production of H₂ gas from steam when the electrochemical cell is operated as an electrolysis cell and may also permit electricity generation from H₂ gas when the electrochemical cell 100 is operated as a fuel cell. The hydrogen electrode 102 may be formed of and include a cermet material including at least one metal and at least one perovskite. By way of non-limiting example, the hydrogen electrode 102 may be formed of and include one or more of a nickel/perovskite cermet (Ni-perovskite) material, such as Ni-BZCYYb (e.g., Ni-BZCYYb1711, Ni-BZCYYb4411, Ni-BZCYYb3511), Ni-BSNYYb, Ni-BaCeO₃, Ni—BaZrO₃, Ni-BZY, Ni—Ba₂(YSn)O_{5.5}, and Ni—Ba₃(CaNb₂)O₉. The hydrogen electrode 102 may include the same perovskite material(s) as the electrolyte 106. In some embodiments, the hydrogen electrode 102 is formed of and includes Ni-BZCYYb.

The oxygen electrode 104 may be formed of and include material compatible with the material of the electrolyte 106 and the material of the hydrogen electrode 102 under the operating conditions (e.g., temperature, pressure, current density) of the electrochemical cell 100. The material composition of the oxygen electrode 104 may facilitate the production of H₂ gas from steam when the electrochemical cell is operated as an electrolysis cell and may also permit electricity generation from H₂ gas when the electrochemical cell 100 is operated as a fuel cell. The material of the oxygen electrode 104 may be a porous material. The oxygen electrode 104 may be formed of and include at least one perovskite material. By way of non-limiting example, the oxygen electrode 104 may be formed of and include one or more of a triple conducting perovskite material, such as Pr(Co_{1-x-y-z}, Niₓ, Mn_{y}, Fe_{z})O_{3-δ}, wherein 0≤x≤0.9, 0≤y≤0.9, 0≤z≤0.9, and δ is an oxygen deficit (e.g., PrNi_{0.5}Co_{0.5}O_{3-δ} (PNC55)), a double perovskite material, such as such as MBa₁₋ₓSrₓCO_{2-y}Fe_{y}O_{5+δ}, wherein x and y are dopant levels, δ is the oxygen deficit, and M is Pr, Nd, or Sm (e.g., PrBa_{0.5}Sr_{0.5}Co_{1.5}Fe_{0.5}O_{5+δ} (PBSCF), NdBa_{0.5}Sr_{0.5}Co_{1.5}Fe_{0.5}O_{5+δ}, SmBa_{0.5}Sr_{0.5}Co_{1.5}Fe_{0.5}O_{5+δ}), a single perovskite material, such as Sm₁₋ₓSrₓCoO_{3-δ} (SSC), BaZr_{1-x-y-z}CoₓFe_{y}Y_{z}O_{3-δ}, or SrScₓNd_{y}Co_{1-x-y}O_{3-δ}, wherein x, y, and z are dopant levels and δ is the oxygen deficit; a Ruddleson-Popper-type perovskite material, such as M₂NiO_{4-δ}, wherein δ is the oxygen deficit and M is La, Pr, Gd, or Sm (e.g., La₂NiO_{4-δ}, Pr₂NiO_{4-δ}, Gd₂NiO_{4-δ}, Sm₂NiO_{4-δ}); and a single perovskite/perovskite composite material such as SSC-BZCYYb. In some embodiments, the oxygen electrode 104 is formed of and includes PNC55.

The hydrogen electrode 102, the oxygen electrode 104, and the electrolyte 106 may each individually exhibit any desired dimensions (e.g., length, width, thickness) and any desired shape, such as one of a cubic shape, a cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, or an irregular shape. The dimensions and the shapes of the hydrogen electrode 102, the oxygen electrode 104, and the electrolyte 106 may be selected relative to one another such that the electrolyte 106 at least substantially intervenes between opposing surfaces of the hydrogen electrode 102 and the oxygen electrode 104. In some embodiments, the hydrogen electrode 102 and the oxygen electrode 104 each individually exhibit a thickness within a range of from about 10 micrometers (μm) to about 1000 μm, and the electrolyte 106 exhibits a thickness within a range of from about 5 μm to about 1000 μm.

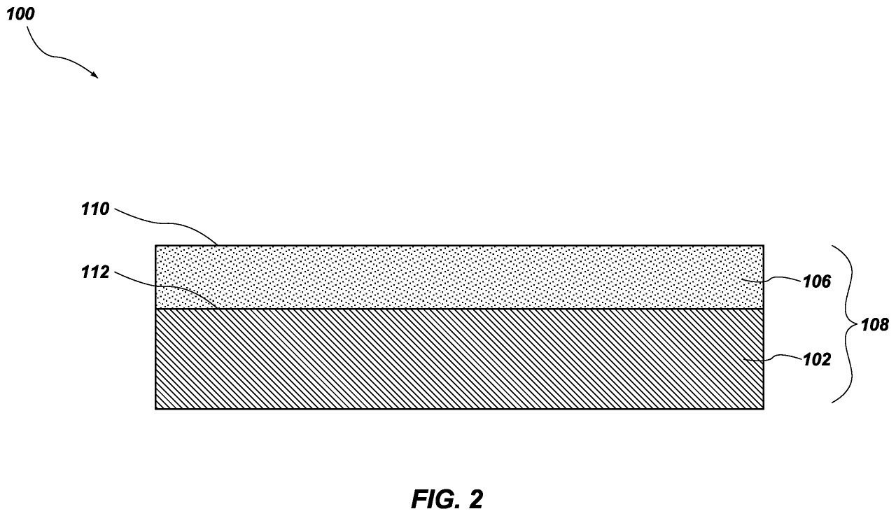

FIG. 2 is a cross-sectional view that illustrates a method of forming the electrochemical cell 100 of FIG. 1, according to embodiments of the disclosure. As shown in FIG. 2, the electrolyte 106 is formed adjacent (e.g., directly adjacent) to the hydrogen electrode 102 to collectively form the hydrogen electrode-electrolyte bi-layer 108. The electrolyte 106 is formed on the hydrogen electrode 102.

The hydrogen electrode 102 and the electrolyte 106 may each individually be formed using conventional processes (e.g., rolling processing, milling processing, shaping processes, pressing processes, consolidation processes), which are not described in detail herein. The hydrogen electrode 102 and the electrolyte 106 are annealed (e.g., sintered, co-sintered) to densify the electrolyte 106 and form the hydrogen electrode-electrolyte bi-layer. The hydrogen electrode 102 and the electrolyte 106 may be annealed at a temperature greater than about 1300° C., such as within a range of from about 1300° C. to about 1700° C. or from about 1400° C. to about 1600° C., for a period of time greater than about 3 hours, such as within a range of from about 3 hours to about 7 hours, from about 4 hours to about 6 hours, or about 5 hours. An exposed surface 110 of the electrolyte 106 opposite the hydrogen electrode 102 may be relatively flat (e.g., relatively smooth) after the hydrogen electrode 102 and the electrolyte 106 are annealed. By way of non-limiting example, surface roughness of the surface 110 of the electrolyte 106 after annealing may be within a range of from about 0.1 μm to about 5 μm.

In some embodiments, the hydrogen electrode-electrolyte bi-layer 108 is formed by a tape-casting process. A green tape of the hydrogen electrode 102 may be prepared by depositing a powder slurry including the hydrogen electrode 102 material(s) onto a substrate having a release material. A green tape of the electrolyte 106 may be prepared by depositing a powder slurry including the electrolyte 106 material(s) onto an additional substrate having a release material. The powder slurry including the hydrogen electrode 102 material(s) and the powder slurry including the electrolyte 106 material(s) may each individually include one or more of a binder, a dispersant, a solvent, or a plasticizer. The powder slurries may each individually be dried on the respective substrates to form the green tape of the hydrogen electrode 102 and the green tape of the electrolyte 106.

The green tape of the hydrogen electrode 102 and the green tape of the electrolyte 106 may each individually exhibit any desired dimensions (e.g., length, width, thickness) and any desired shape, such as one of a cubic shape, a cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, or an irregular shape, in order to produce the desired dimensions of the hydrogen electrode 102 and the electrolyte 106.

At least one piece (e.g., layer) of the green tape of the hydrogen electrode 102 and at least one piece (e.g., layer) of the green tape of the electrolyte 106 may be laminated by hot press at a temperature within a range of from about 50° C. to about 100° C., such as about 70° C., under a pressure within a range of from about 3 tons to about 5 tons, such as about 4 tons (e.g., from about 3000 kilograms (kg) to about 5000 kilograms, such as about 4000 kg) for a period of time within a range of from about 4 hours to about 6 hours, such as about 5 hours. In some embodiments, two or more pieces (e.g., layers) of the green tape of the hydrogen electrode 102 and one piece (e.g., layer) of the green tape of the electrolyte 106 are laminated. The laminated green tapes may be pre-annealed (e.g., pre-sintered) at a temperature within a range of from about 800° C. to about 1100° C., such as from about 900° C. to about 1000° C., for a period of time within a range of from about 1 hour to about 5 hours, such as from about 2 hour to about 4 hours or about 3 hours, to remove any organic materials from the laminated green tapes. The laminated green tapes may be annealed (e.g., sintered, co-sintered) at a temperature greater than about 1300° C., such as within a range of from about 1300° C. to about 1700° C. or from about 1400° C. to about 1600° C., for a period of time greater than about 3 hours, such as within a range of from about 3 hours to about 7 hours, from about 4 hours to 6 hours, or about 5 hours. In some embodiments, the pre-annealed laminated green tapes are annealed at a temperature of about 1400° C. for about 5 hours.

After annealing the hydrogen electrode 102 and the electrolyte 106, the electrolyte 106 is exposed to one or more surface treatment acts (e.g., surface treatments) to increase surface roughness of a surface 110 of the electrolyte 106 opposite the hydrogen electrode 102. However, one or more of the surface treatment acts may be conducted without first annealing the hydrogen electrode 102 and the electrolyte 106. The one or more surface treatments may remove a portion of the electrolyte 106 adjacent to (e.g., directly adjacent to) the surface 110. The one or more surface treatments may include exposing the electrolyte 106 to one or more of an acid solution, a plasma, thermal shock, or gamma radiation. In some embodiments, the one or more surface treatments includes a series of (e.g., more than one) surface treatments. The series of surface treatments may include one or more repeated surface treatments. In other words, if multiple surface treatments are conducted, the multiple treatments may include multiple surface treatments of the same type or may include a combination of different types of surface treatments. By way of non-limiting example, the one or more surface treatments may include exposing the electrolyte 106 to one or more acid solutions, one or more plasmas, thermal shock at one or more temperatures and/or for one or more periods of time, or gamma radiation at one or more wavelengths and/or for one or more periods of time. The increased surface roughness of the electrolyte 106 may result in an increased effective surface area of the surface 110 of the electrolyte 106.

The electrolyte 106 may be exposed to the one or more surface treatments for any period of time sufficient to obtain a suitable (e.g., desired) surface roughness of the surface 110 of the electrolyte 106 and maintain a desired thickness of the electrolyte 106. As a non-limiting example, the electrolyte 106 may be exposed to each of the one or more surface treatments individually for a period of time within a range of from about 10 seconds to about 60 minutes, such as from about 10 seconds to about 2 minutes, from about 10 seconds to about 5 minutes, from about 10 seconds to about 10 minutes, from about 1 minute to about 10 minutes, 1 minute to about 30 minutes, from about 5 minutes to about 10 minutes, from about 5 minutes to about 15 minutes, from about 5 minutes to about 30 minutes, from about 10 minutes to about 20 minutes, from about 10 minutes to about 30 minutes, from about 10 minutes to about 50 minutes, from about 20 minutes to about 40 minutes, from about 20 minutes to about 60 minutes, or from about 30 minutes to about 60 minutes. In some embodiments, the electrolyte 106 is exposed to each of the one or more surface treatments for a period of time within a range of from about 5 minutes to about 15 minutes. In some embodiments, the electrolyte 106 is exposed to each of the one or more surface treatments for a period of time of about 10 minutes.

In some embodiments, at least one of the one or more surface treatments is an etch process, such as a wet etch process, in which the electrolyte 106 is exposed to an acid solution to remove a portion of the electrolyte 106 and increase surface roughness of the surface 110 of the electrolyte 106. By way of non-limiting example, the acid solution may be a solution of nitric acid (HNO₃), hydrochloric acid (HCl), sulfuric acid (H₂SO₄), phosphoric acid (H₃PO₄), or a combination thereof. The acid solution may be an aqueous solution. A concentration of the acid in the acid solution may be sufficient to remove the portion of the electrolyte 106, such within a range of from about 0.4% by weight (wt %) to about 80 wt %, such as from about 0.45 wt % to about 73 wt %, from about 0.4 wt % to about 10 wt %, from about 0.4 wt % to about 30 wt %, from about 0.5 wt % to about 80 wt %, from about 1 wt % to about 15 wt %, from about 1 wt % to about 40 wt %, from about 1 wt % to about 60 wt %, from about 1 wt % to about 75 wt %, from about 10 wt % to about 40 wt %, from about 20 wt % to about 60 wt %, from about 30 wt % to about 70 wt %, from about 50 wt % to about 80 wt %, or from about 60 wt % to about 80 wt %. In some embodiments, a concentration of acid in the acid solution is within a range of from about 60 wt % to about 80 wt %. In some embodiments, a concentration of acid in the acid solution is about 70 wt %.

Exposing the electrolyte 106 to a plasma (e.g., a plasma treatment) may include exposing the electrolyte 106 to one or more of an oxygen plasma, an argon plasma, a hydrogen plasma, or a plasma of air. Exposing the electrolyte 106 to the plasma may remove a portion of the electrolyte 106 to increase surface roughness of the surface 110 of the electrolyte 106.

Exposing the electrolyte 106 to thermal shock (e.g., a thermal shock treatment) may include one or more of increasing or decreasing a temperature of the electrolyte 106. The thermal shock treatment may include increasing a temperature of the electrolyte 106 at a rate within a range of from about 10° C. sec⁻¹ to about 1000° C. sec⁻¹ to an elevated temperature within a range of from about 100° C. to about 2000° C. The thermal shock treatment may include decreasing a temperature of the electrolyte 106 at a rate within a range of from about-10° C. sec⁻¹ to about −1000° C. sec⁻¹ to a decreased temperature within a range of from about 100° C. to about 2000° C. Exposing the electrolyte 106 to the thermal shock treatment increases surface roughness of the surface 110 of the electrolyte 106.

Exposing the electrolyte 106 to gamma radiation (e.g., a gamma radiation treatment) may include exposing the electrolyte 106 to gamma radiation having a wavelength less than about 100 picometers (pm), such as within a range of from about 10 pm to about 100 pm. Exposing the electrolyte 106 to the gamma radiation treatment increases surface roughness of the surface 110 of the electrolyte 106.

After the electrolyte 106 is exposed to the one or more surface treatments, surface roughness of the surface 110 of the electrolyte may be determined by calculating an average distance between adjacent peaks and valleys of the surface 110. The surface roughness may be within a range of from about 0.1 μm to about 5 μm, such as from about 0.1 μm to about 1 μm, from about 0.1 μm to about 2 μm, from about 0.1 μm to about 4 μm, from about 0.5 μm to about 1 μm, from about 0.5 μm to about 3 μm, from about 0.5 μm to about 5 μm, from about 1 μm to about 3 μm, from about 1 μm to about 5 μm, from about 2 μm to about 4 μm, from about 2 μm to about 5 μm, from about 3 μm to about 5 μm, or from about 4 μm to about 5 μm. In some embodiments, surface roughness of the surface 110 of the electrolyte 106 is within a range of from about 0.5 μm to about 1 μm after exposure to the one or more surface treatments.

With reference to FIG. 1, the oxygen electrode 104 is formed adjacent to (e.g., directly adjacent to) the surface 110 of the electrolyte 106 opposite the hydrogen electrode 102. An electrolyte/oxygen electrode/inlet gas of the oxygen electrode triple-phase boundary may be formed at the interface when the oxygen electrode 104 is formed directly adjacent to the electrolyte 106. The oxygen electrode 104 may be formed using conventional processes (e.g., rolling processing, milling processing, shaping processes, pressing processes, consolidation processes, screen-printing processes, painting processes), which are not described in detail herein. The oxygen electrode 104, the electrolyte 106, and the hydrogen electrode 102 are annealed at a temperature within a range of from about 800° C. to about 1200° C., such as about 1000° C., to bond the oxygen electrode 104 to the electrolyte 106 along an oxygen electrode-electrolyte interface 112 disposed between the oxygen electrode 104 to the electrolyte 106 and form the electrochemical cell 100.

The oxygen electrode-electrolyte interface 112 may exhibit a peeling strength corresponding (e.g., correlating) to the surface roughness of the surface 110 of the electrolyte 106. By way of a non-limiting example, the oxygen electrode-electrolyte interface 112 may exhibit a peeling strength within a range of from about 17 Newtons (N) to about 40 N, such as from about 17 N to about 35 N, from about 17 N to about 25 N, from about 20 N to about 35 N, from about 20 N to about 30 N, from about 20 N to about 40 N, or from about 25 N to about 40 N. In some embodiments, the oxygen electrode-electrolyte interface 112 exhibits a peeling strength of at least about 23 N. In some embodiments, the oxygen electrode-electrolyte interface 112 exhibits a peeling strength of about 23.5 N.

Exposing the surface 110 of the electrolyte 106 to the one or more surface treatments may increase the interfacial bond strength of the oxygen electrode 104 and the electrolyte 106 along the oxygen electrode-electrolyte interface 112. Removing a portion of the electrolyte 106 adjacent to the surface 110 by exposing the surface 110 to the one or more surface treatments enables deficiency of an A-site cation at the surface 110 of the electrolyte to be increased, improving A-site cation inter-diffusion (e.g., oxide-oxide wetting) between the material of the oxygen electrode 104 and the material of the electrolyte 106 and further increasing the bond strength between the oxygen electrode 104 and the electrolyte 106. In addition, increasing surface roughness of the surface 110 of the electrolyte 106 by exposing the surface 110 to the one or more surface treatments enables an effective surface area of the surface 110 to be increased. By increasing the effective surface area of the surface 110 and improving interfacial strength and bond strength along the oxygen electrode-electrolyte interface 112, a contact area (e.g., number of contacts) and a number of reaction sites near the oxygen electrode-electrolyte interface 112 may be increased, enabling the electrochemical cell 100 to approach or achieve intrinsic bulk proton conductivity, improving electrochemical performance and long-term stability of the electrochemical cell 100. In comparison, conventional electrochemical cells formed without exposing the electrolyte 106 to the one or more surface treatments exhibit high ohmic loss as a result of extended proton conduction through the oxygen electrode due to poor bonding, limited contact, and a decreased number of reaction sites near the interface between the electrolyte and the oxygen electrode.

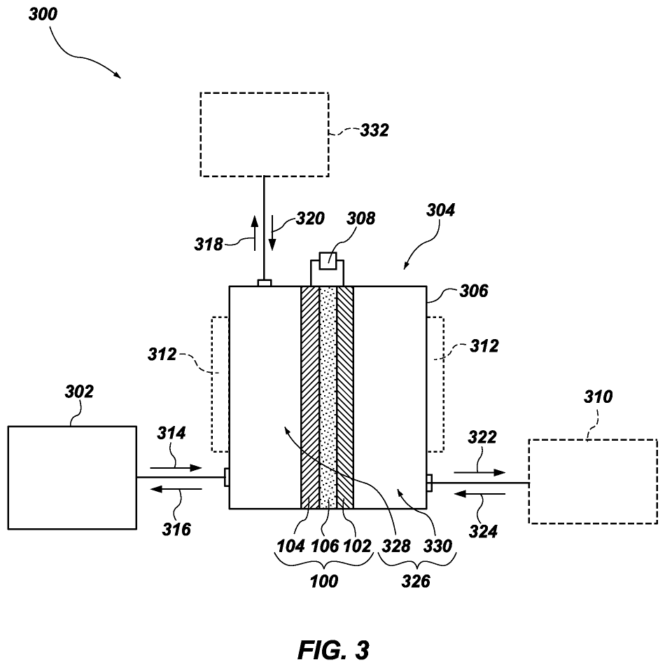

Electrochemical cells (e.g., the electrochemical cell 100) in accordance with embodiments of this disclosure may be used in embodiments of H₂ gas production and electricity generation systems of the disclosure. For example, FIG. 3 schematically illustrates a system 300 for producing H₂ gas and generating electricity, according to embodiments of the disclosure. As shown in FIG. 3, the system 300 includes at least one steam source 302, and at least one electrochemical apparatus 304 in fluid communication with the steam source 302. The electrochemical apparatus 304 includes a housing structure 306, and one or more embodiments of the electrochemical cell 100 previously described with reference to FIG. 1 contained within the housing structure 306. The electrochemical cell 100 is electrically connected (e.g., coupled) to a power source 308, and includes the oxygen electrode 104 (e.g., steam side electrode), the hydrogen electrode 102 (e.g., H₂ gas side electrode), and the electrolyte 106 between the oxygen electrode 104 and the hydrogen electrode 102. As shown in FIG. 3, the system 300 may optionally include one or more of at least one H₂ gas source 310 in fluid communication with the electrochemical apparatus 304, at least one O₂ gas source 332 in fluid communication with the electrochemical apparatus 304, and at least one heating apparatus 312 operatively associated with the electrochemical apparatus 304.

The steam source 302 comprises at least one apparatus configured and operated to produce a steam stream 314 including steam (e.g., gaseous H₂O). The steam stream 314 may be directed into the electrochemical apparatus 304 from the steam source 302 to interact with the oxygen electrode 104 of the electrochemical cell 100 when the electrochemical cell 100 is operated as an electrolysis cell, as described in further detail below. The steam source 302 may also receive an H₂O stream 316 containing one or more phases of H₂O (e.g., steam) exiting the electrochemical apparatus 304 when the electrochemical cell 100 is operated as a fuel cell, as also described in further detail below. By way of non-limiting example, the steam source 302 may comprise a boiler apparatus configured and operated to heat liquid H₂O to a temperature greater than or equal to about 100° C. In some embodiments, the steam source 302 is configured and operated to convert the liquid H₂O to steam having a temperature within a range of an operating temperature of the electrochemical cell 100 of the electrochemical apparatus 304, such as a temperature within a range of from about 400° C. to about 600° C. In some embodiments, the steam source 302 is configured and operated to convert the liquid H₂O into steam having a temperature below the operating temperature of the electrochemical cell 100. In such embodiments, the heating apparatus 312 may be employed to further heat the steam stream 314 to the operational temperature of the electrochemical cell 100, as described in further detail below.

The electrochemical apparatus 304, including the housing structure 306 and the electrochemical cell 100 thereof, is configured and operated to facilitate the production of H₂ gas from steam (e.g., steam of the steam stream 314) when the electrochemical cell 100 is operated as an electrolysis cell, and to facilitate the electricity generation from H₂ gas (e.g., the H₂ gas produced when the electrochemical cell 100 is operated as an electrolysis cell) when the electrochemical cell 100 is operated as a fuel cell. The housing structure 306 may exhibit any shape (e.g., a tubular shape, a quadrilateral shape, a spherical shape, a semi-spherical shape, a cylindrical shape, a semi-cylindrical shape, truncated versions thereof, or an irregular shape) and size able to contain (e.g., hold) the electrochemical cell 100 therein. In addition, the housing structure 306 is configured, such that when the electrochemical cell 100 is operated as an electrolysis cell, the housing structure 306 may receive and direct the steam stream 314 to the oxygen electrode 104 of the electrochemical cell 100, may direct O₂ gas produced at the oxygen electrode 104 of the electrochemical cell 100 away from the electrochemical apparatus 304 as an O₂ gas stream 318, and may optionally direct H₂ gas produced at the hydrogen electrode 102 of the electrochemical cell 100 away from the electrochemical apparatus 304 as an H₂ gas stream 322. The housing structure 306 may also be configured, such that when the electrochemical cell 100 is operated as a fuel cell, the housing structure 306 may receive and direct a H₂ gas containing stream 324 to the hydrogen electrode 102 of the electrochemical cell 100, may receive and direct an O₂ gas containing stream 320 to the oxygen electrode 104 of the electrochemical cell 100, and may direct H₂O produced at the oxygen electrode 104 of the electrochemical cell 100 away from the electrochemical apparatus 304 as an H₂O stream 316. The housing structure 306 may be formed of and include any material (e.g., glass, metal, alloy, polymer, ceramic, composite, combination thereof, etc.) compatible with the operating conditions (e.g., temperatures, pressures, etc.) of the electrochemical apparatus 304.

The housing structure 306 of the electrochemical apparatus 304 may at least partially define at least one internal chamber 326 at least partially surrounding the electrochemical cell 100. The electrochemical cell 100 may serve as a boundary between a first region 328 (e.g., a steam region) of the internal chamber 326 configured and positioned to temporarily contain steam, and a second region 330 (e.g., an H₂ gas region) of the internal chamber 326 configured and positioned to temporarily contain H₂ gas. H₂O (e.g., steam) may be substantially limited to the first region 328 of the internal chamber 326 by the configurations and positions of the housing structure 306 and the electrochemical cell 100. Keeping the second region 330 of the internal chamber 326 substantially free of the H₂O circumvents additional processing of produced H₂ gas (e.g., to separate the produced H₂ gas from steam) that may otherwise be necessary if the H₂O (e.g., steam) was provided within the second region 330 of the internal chamber 326. In addition, protecting the hydrogen electrode 102 of the electrochemical cell 100 from exposure to H₂O may enhance the operational life (e.g., durability) of the electrochemical cell 100 as compared to conventional electrochemical cells by preventing undesirable oxidation of the hydrogen electrode 102 that may otherwise occur in the presence of H₂O.

Although the electrochemical apparatus 304 is depicted in FIG. 3 as including a single (i.e., only one) electrochemical cell 100, the electrochemical apparatus 304 may include any number of electrochemical cells 100. Put another way, the electrochemical apparatus 304 may include a single (e.g., only one) electrochemical cell 100, or may include multiple (e.g., more than one) electrochemical cells 100 that are operatively coupled to one another. If the electrochemical apparatus 304 includes multiple electrochemical cells 100, each of the electrochemical cells 100 may be substantially the same (e.g., exhibit substantially the same components, component sizes, component shapes, component material compositions, component material distributions, component positions, component orientations, etc.) and may be operated under substantially the same conditions (e.g., substantially the same temperatures, pressures, flow rates, etc.), or at least one of the electrochemical cells 100 may be different (e.g., exhibit one or more of different components, different component sizes, different component shapes, different component material compositions, different component material distributions, different component positions, different component orientations, etc.) than at least one other of the electrochemical cells 100 and/or may be operated under different conditions (e.g., different temperatures, different pressures, different flow rates, etc.) than at least one other of the electrochemical cells 100. By way of non-limiting example, one of the electrochemical cells 100 may be configured for and operated under a different temperature (e.g., different operating temperature resulting from a different material composition of one of more components thereof) than at least one other of the electrochemical cells 100. In some embodiments, two of more electrochemical cells 100 are provided in parallel with one another within the housing structure 306 of the electrochemical apparatus 304.

Although the system 300 is depicted as including a single (i.e., only one) electrochemical apparatus 304 in FIG. 3, the system 300 may include any number of electrochemical apparatuses 304. Put another way, the system 300 may include a single (e.g., only one) electrochemical apparatus 304, or may include multiple (e.g., more than one) electrochemical apparatuses 304 that are operatively coupled to one another. If the system 300 includes multiple electrochemical apparatuses 304, each of the electrochemical apparatuses 304 may be substantially the same (e.g., exhibit substantially the same components, component sizes, component shapes, component material compositions, component material distributions, component positions, component orientations, etc.) and may be operated under substantially the same conditions (e.g., substantially the same temperatures, pressures, flow rates, etc.), or at least one of the electrochemical apparatus 304 may be different (e.g., exhibit one or more of different components, different component sizes, different component shapes, different component material compositions, different component material distributions, different component positions, different component orientations, etc.) than at least one other of the electrochemical apparatuses 304 and/or may be operated under different conditions (e.g., different temperatures, different pressures, different flow rates, etc.) than at least one other of the electrochemical apparatuses 304. By way of non-limiting example, one of the electrochemical apparatuses 304 may be configured for and operated under a different temperature (e.g., a different operating temperature resulting from a different material composition of one of more components of one or more electrochemical cell(s) 100 thereof) than at least one other of the electrochemical apparatuses 304. In some embodiments, two of more electrochemical apparatuses 304 are provided in parallel with one another. In some embodiments, two of more electrochemical apparatuses 304 are provided in series with one another.

The power source 308 may comprise one or more of a device, structure, and apparatus able to apply a potential difference (e.g., voltage) between the oxygen electrode 104 of the electrochemical cell 100 and the hydrogen electrode 102 of the electrochemical cell 100 to facilitate desired operation (e.g., operation as an electrolysis cell, operation as a fuel cell) of the electrochemical cell 100. During operation of the electrochemical cell 100 as an electrolysis cell, the potential difference applied between the oxygen electrode 104 and the hydrogen electrode 102 permits the oxygen electrode 104 to serve as a positive electrode (e.g., anode) and the hydrogen electrode 102 to serve as a negative electrode (e.g., cathode) to facilitate water splitting reaction (WSR) and the production of H₂ gas from steam, as described in further detail below. During operation of the electrochemical cell 100 as a fuel cell, the potential difference applied between the oxygen electrode 104 and the hydrogen electrode 102 permits the hydrogen electrode 102 to serve as the positive electrode (e.g., anode) and the oxygen electrode 104 to serve as the negative electrode (e.g., cathode) to facilitate oxygen reduction reaction (ORR) and the electricity generation using H₂ gas as a fuel, as also described in further detail below. The power source 308 may, for example, comprise one or more of a device, structure, or apparatus configured and operated to exploit one or more of solar energy, wind (e.g., wind turbine) energy, hydropower energy, geothermal energy, nuclear energy, combustion-based energy, and waste heat (e.g., heat generated from one or more of an engine, a chemical process, and a phase change process) to apply a potential difference between the oxygen electrode 104 and the hydrogen electrode 102 of the electrochemical cell 100.

The heating apparatus 312, if present, may comprise at least one apparatus (e.g., one or more of a combustion heater, an electrical resistance heater, an inductive heater, and an electromagnetic heater) configured and operated to heat one or more of at least a portion of the electrochemical apparatus 304 and one or more of the streams (e.g., one or more of the steam stream 314, the H₂ gas containing stream 324, and the O₂ gas containing stream 320) directed into the electrochemical apparatus 304 during desired operation (e.g., operation as an electrolysis cell, operation as a fuel cell) of the electrochemical cell 100 to an operating temperature of the electrochemical apparatus 304. The operating temperature of the electrochemical apparatus 304 may at least partially depend on the material compositions of the oxygen electrode 104, the electrolyte 106, and the hydrogen electrode 102 thereof. In some embodiments, the heating apparatus 312 heats one or more of at least a portion of the electrochemical apparatus 304 and one or more of the streams directed into the electrochemical apparatus 304 to a temperature within a range of from about 400° C. to about 600° C. In additional embodiments, such as in embodiments where the temperature of the streams is already within the operating temperature range of the electrochemical cell 100 of the electrochemical apparatus 304, the heating apparatus 312 may be omitted (e.g., absent) from the system 300.

The H₂ gas source 310, if present, may comprise one or more of a device, structure, and apparatus configured and operated to produce an H₂ gas containing stream 324 including H₂ gas. The H₂ gas containing stream 324 may be directed into the electrochemical apparatus 304 from the H₂ gas source 310 to interact with the hydrogen electrode 102 of the electrochemical cell 100 when the electrochemical cell 100 is operated in as a fuel cell, as described in further detail below. The H₂ gas source 310 may also receive and temporarily store (e.g., contain) one or more portions of the H₂ gas stream 322 including H₂ gas exiting the electrochemical apparatus 304 when the electrochemical cell 100 is operated as an electrolysis cell, as also described in detail below. The H₂ gas exiting the electrochemical apparatus 304 in the H₂ gas stream 322 during operation of the electrochemical cell 100 as an electrolysis cell may be employed as at least a portion of the H₂ gas of the H₂ gas containing stream 324 being directed into the electrochemical apparatus 304 when the electrochemical cell 100 is operated as a fuel cell. In additional embodiments, such as in embodiments wherein the electrochemical cell 100 is rapidly switched (e.g., in under five (5) minutes, such as in under two (2) minutes, or in under one (1) minute) between operation as an electrolysis cell and operation as a fuel cell, the H₂ gas source 310 may be omitted. In such embodiments, the at least a portion (e.g., substantially all) of the H₂ gas produced during operation of the electrochemical cell 100 as an electrolysis cell may be employed as fuel during operation of the electrochemical cell 100 as a fuel cell before the produced H₂ gas exits the second region 330 of the internal chamber 326 of the housing structure 306.

The O₂ gas source 332, if present, may comprise one or more of a device, structure, and apparatus configured and operated to produce an O₂ gas containing stream 320 including O₂ gas. The O₂ gas containing stream 320 may be directed into the electrochemical apparatus 304 from the O₂ gas source 332 to interact with the oxygen electrode 104 of the electrochemical cell 100 when the electrochemical cell 100 is operated as a fuel cell, as described in further detail below. The O₂ gas source 332 may also receive and temporarily store (e.g., contain) one or more portions of the O₂ gas stream 318 including O₂ gas exiting the electrochemical apparatus 304 when the electrochemical cell 100 is operated as an electrolysis cell. The O₂ gas exiting the electrochemical apparatus 304 in the O₂ gas stream 318 during operation of the electrochemical cell 100 as an electrolysis cell may be employed as at least a portion of the O₂ gas of the O₂ gas containing stream 320 being directed into the electrochemical apparatus 304 when the electrochemical cell 100 is operated as a fuel cell.

When the electrochemical cell 100 of the electrochemical apparatus 304 (and, hence, the electrochemical apparatus 304 itself) is operated as an electrolysis cell, the system 300 directs the steam stream 314 from the steam source 302 and into the electrochemical apparatus 304 to interact with the oxygen electrode 104 (e.g., steam side electrode) of the electrochemical cell 100 contained therein. A potential difference (e.g., voltage) is applied between the oxygen electrode 104 (serving as an anode) and the hydrogen electrode 102 (serving as a cathode) by the power source 308 so that as steam interacts with the oxygen electrode 104, H atoms of the steam release their electrons (e⁻) to generate oxygen gas (O_{2(g)}), hydrogen ions (H⁺) (i.e., protons), and electrons (e⁻) according to the following equation:

$$2 {H}_{2} {O}_{( g )} \to {O}_{2 ( g )} + 4 {H}^{+} + 4 {e}^{-} . \qquad ( 1 )$$

The generated H⁺ permeate (e.g., diffuse) across the electrolyte 106 to the hydrogen electrode 102, and the generated e⁻ are directed to the power source 308 through external circuitry (not shown). The produced O₂ gas may exit the electrochemical apparatus 304 as an O₂ gas stream 318. At the hydrogen electrode 102, the generated H⁺ exiting the electrolyte 106 react with e received from the power source 308 to form H atoms, which then combine to form H₂ gas (H_{2(g)}), according to the following equation:

$$4 {H}^{+} + 4 {e}^{-} \to 2 {H}_{2 ( g )} . \qquad ( 2 )$$

The produced H₂ gas may exit the electrochemical apparatus 304 as the H₂ gas stream 322.

When the electrochemical cell 100 of the electrochemical apparatus 304 (and, hence, the electrochemical apparatus 304 itself) is operated as a fuel cell, the system 300 employs H₂ gas previously produced by the electrochemical cell 100 when operated as an electrolysis cell and/or directed into electrochemical apparatus 304 (e.g., into the second region 330 thereof) from the H₂ gas source 310 as a gaseous H₂ stream 316 to interact with the hydrogen electrode 102 (e.g., H₂ gas side electrode) of the electrochemical cell 100. A potential difference (e.g., voltage) is applied between the hydrogen electrode 102 (serving as an anode) and the oxygen electrode 104 (serving as a cathode) by the power source 308 so that as H₂ gas interacts with the hydrogen electrode 102, H atoms of the H₂ gas release their electrons (e⁻) to generate hydrogen ions (H⁺) (i.e., protons) and electrons (e⁻) according to the following equation (the reverse reaction of Equation (2) above):

$$2 {H}_{2 ( g )} \to 4 {H}^{+} + 4 {e}^{-} . \qquad ( 3 )$$

The generated H⁺ permeate (e.g., diffuse) across the electrolyte 106 to the oxygen electrode 104, and the generated e are directed to the power source 308 through external circuitry. At the oxygen electrode 104, the generated H⁺ exiting the electrolyte 106 react with e⁻ received from the power source 308 and O₂ gas previously produced by the electrochemical cell 100 when operated in as an electrolysis cell and/or directed into electrochemical apparatus 304 (e.g., into the first region 328 thereof) from the O₂ gas source 332 as an O₂ gas containing stream 320 to generate electricity and produce H₂O, according to the following equation (the reverse reaction of Equation (1) above):

$${O}_{2 ( g )} + 4 {H}^{+} + 4 {e}^{-} \to 4 {H}_{2} O . \qquad ( 4 )$$

The produced H₂O may exit the electrochemical apparatus 304 as the H₂O stream 316 and may be directed into the steam source 302, and/or may be employed to produce additional H₂ gas when the electrochemical cell 100 of the electrochemical apparatus 304 (and, hence, the electrochemical apparatus 304 itself) is operated as an electrolysis cell.

Switching between operation of the electrochemical cell 100 as an electrolysis cell and operation of the electrochemical cell 100 as a fuel cell may be rapid (e.g., electrolysis and fuel cell operation modes may alternate between one another using relatively short time periods for each operation, such as time periods less than or equal to about five (5) minutes, less than or equal to about two (2) minutes, or less than or equal to about one (1) minute), or may be delayed (e.g., the electrolysis and fuel cell operation modes may not alternate between one another using relatively short time periods). In some embodiments, such as embodiments wherein the electrochemical cell 100 is rapidly switched (e.g., cyclically alternated) between operation as an electrolysis cell and operation as a fuel cell, at least a portion (e.g., substantially all) of the H₂ gas produced during operation of the electrochemical cell 100 as an electrolysis cell is consumed as fuel during operation of the electrochemical cell 100 as a fuel cell before the produced H₂ gas can exit the electrochemical apparatus 304 as the H₂ gas stream 322. In additional embodiments, such as embodiments wherein the electrochemical cell 100 is not rapidly switched between operation as an electrolysis cell and operation as a fuel cell, at least a portion (e.g., substantially all) of the H₂ gas produced during operation of the electrochemical cell 100 as an electrolysis cell may exit the electrochemical apparatus 304 as the H₂ gas stream 322 and may be stored (e.g., at the H₂ gas source 310, if any) for subsequent use (e.g., for subsequent use as fuel during relatively delayed operation of the electrochemical cell 100 as a fuel cell), as desired.

Still referring to FIG. 3, streams exiting the electrochemical apparatus 304 during the different modes of operation (e.g., operation as an electrolysis cell, operation of a fuel cell) of the electrochemical cell 100 may individually be utilized or disposed of as desired. In some embodiments, one or more of the H₂ gas stream 322 and the O₂ gas stream 318 produced during operation of the electrochemical cell 100 as an electrolysis cell are respectively delivered into one or more storage vessels of the H₂ gas source 310 and the O₂ gas source 332 for subsequent use (e.g., to respectively form the H₂ gas containing stream 324 and the O₂ gas containing stream 320 employed during operation of the electrochemical cell 100 as a fuel cell), as desired. In additional embodiments, the H₂O stream 316 produced during operation of the electrochemical cell 100 as a fuel cell is delivered into one or more storage vessels of the steam source 302 for subsequent use (e.g., to form the steam stream 314 employed during operation of the electrochemical cell 100 as an electrolysis cell), as desired. In further embodiments, at least a portion of one or more of the streams (e.g., the H₂ gas stream 322 and the O₂ gas stream 318) may be utilized (e.g., combusted) to heat one or more components (e.g., the heating apparatus 312 (if present); the electrochemical apparatus 304; etc.) and/or other streams (e.g., the steam stream 314) of the system 300. By way of non-limiting example, if the heating apparatus 312 (if present) is a combustion-based apparatus, at least a portion of one or more of the H₂ gas stream 322 and the O₂ gas stream 318 may be directed into the heating apparatus 312 and undergo an combustion reaction to efficiently heat the steam stream 314 entering the electrochemical apparatus 304 and/or at least a portion of the electrochemical apparatus 304 during operation of the electrochemical cell 100 as an electrolysis cell. Utilizing the hydrocarbon H₂ gas stream 322 and/or the O₂ gas stream 318 as described above may reduce the electrical power requirements of the system 300 by enabling the utilization of direct thermal energy.

Thermal energy input into (e.g., through the heating apparatus 312 (if present)) and/or generated by the electrochemical apparatus 304 may also be used to heat one or more other components and/or streams of the system 300. As a non-limiting example, during operation of the electrochemical cell 100 as an electrolysis cell, one or more of the H₂ gas stream 322 and the O₂ gas stream 318 exiting the electrochemical apparatus 304 may be directed into a heat exchanger configured and operated to facilitate heat exchange between the H₂ gas stream 322 and/or the O₂ gas stream 318 of the system 300 and one or more other relatively cooler streams (e.g., in some embodiments, the steam stream 314) of the system 300 to transfer heat from the H₂ gas stream 322 and/or the O₂ gas stream 318 to the relatively cooler stream(s) to facilitate the recovery of the thermal energy input into and generated within the electrochemical apparatus 304. The recovered thermal energy may increase process efficiency and/or reduce operational costs without having to react (e.g., combust) the H₂ gas stream 322 and/or the O₂ gas stream 318. As another non-limiting example, during operation of the electrochemical cell 100 as a fuel cell, the H₂O stream 316 exiting the electrochemical apparatus 304 may be directed into a heat exchanger configured and operated to facilitate heat exchange between the H₂O stream 316 of the system 300 and one or more other relatively cooler streams (e.g., in some embodiments, one or more of the O₂ gas containing stream 320 and the H₂ gas containing stream 324) of the system 300 to transfer heat from the H₂O stream 316 to the relatively cooler stream(s) to facilitate the recovery of the thermal energy input into and generated within the electrochemical apparatus 304. The recovered thermal energy may increase process efficiency and/or reduce operational costs without having to react (e.g., combust) one or more of the streams employed in the system 300.

The electrochemical cells (e.g., the electrochemical cell 100), systems (e.g., the system 300), and methods of the disclosure enable a bulk proton conductivity to approach or achieve a theoretical bulk proton conductivity (e.g., intrinsic bulk proton conductivity), improving electrochemical performance at intermediate temperatures, such as temperatures within a range of from about 400° to about 600° C. The electrochemical cells, systems, and methods of the disclosure may reduce one or more of the time (e.g., processing acts), costs (e.g., material costs), and energy (e.g., thermal energy, electrical energy, etc.) utilized to produce H₂ gas and/or generate electricity relative to conventional electrochemical cells, systems, and methods. The electrochemical cells, systems, and methods of the disclosure may be more efficient, durable, and reliable than conventional electrochemical cells, conventional systems, and conventional methods of H₂ gas production and electricity. The methods of the disclosure may be applied in various technologies and industries including, but not limited to, power industry applications, petrochemical industry applications, and other energy-intense industrial applications, including, but not limited to ammonia industry applications, Li-ion batteries, fuel cells, electrolyzers, supercapacitors, biomass conversion, and fuel-efficient vehicles.

The following examples serve to explain embodiments of the disclosure in more detail. These examples are not to be construed as being exhaustive, exclusive, or otherwise limiting as to the scope of the disclosure.

### EXAMPLES

### Example 1

### Materials Synthesis

BZCYYb was synthesized by a solid-state reaction method. Stoichiometric amounts of BaCO₃ (99.8% purity), ZrO₂ (99% purity), CeO₂ (99.9% purity), Y₂O₃ (99.9% purity), and Yb₂O₃ (99.9% purity) were mixed by ball milling in ethanol for 12 hours, followed by drying, grinding, and heat treatment at 1100° C. for 8 hours to obtain phase-pure BZCYYb powders.

PNC55 was synthesized by the Pechini method. Stoichiometric Pr(NO₃)₃·6H₂O (99.9% purity), Ni(NO₃)₂·6H₂O (99% purity), and Co(NO₃)₂·6H₂O (99% purity) were dissolved in deionized water to prepare an aqueous solution containing 0.05 mol L⁻¹ Pr³⁺, 0.025 mol L⁻¹ Ni²⁺, and 0.025 mol L⁻¹ Co²⁺. Next, 0.2 mol L⁻¹ glycol and 0.1 mol L⁻¹ citric acid were added to the aqueous solution. The prepared solution was heated to 80° C. on a hot plate with continuous stirring until converted to a gel. The obtained gel was heated to 350° C. and followed with an auto-ignition process to produce a black foamy intermediate product. Final PNC55 powders were obtained by annealing the intermediate product at 1100° C. for 4 hours. La_{0.6}Sr_{0.4}Co_{0.2}Fe_{0.8}O_{3-δ} (LSCF), PrBa_{0.5}Sr_{0.5}Co_{1.5}Fe_{0.5}O_{5+δ} (PBSCF), and PrNi_{0.7}Co_{0.3}O_{3-δ} (PNC73) were similarly synthesized by the same Pechini method following their stoichiometries.

A three-dimensional (3D) PNC73 mesh was fabricated by a template-derived method. Stoichiometric Pr(NO₃)₃·6H₂O (99.9% purity), Ni(NO₃)₂·6H₂O (99% purity), and Co(NO₃)₂·6H₂O (99%, purity) were dissolved in deionized water to prepare a nitrate precursor solution containing 0.05 mol L⁻¹ Pr³⁺, 0.035 mol L⁻¹ Ni²⁺, and 0.015 mol L⁻¹ Co²⁺. A piece of fabric textile (Telio, Montreal, CA) was immersed into the precursor solution for 24 hours and then heat-treated at 750° C. for 2 hours to form a 3D PNC73 mesh.

### Example 2

### Cell Fabrication

Hydrogen electrode-supported cells were fabricated by a tape-casting process. To prepare green tapes of the hydrogen electrode, NiO and BZCYYb powders as described in Example 1 were mixed with 6:4 weight ratio by ball milling in ethanol and toluene for 24 hours. Next, a binder of polyvinyl butyral (PVB), a plasticizer of butyl benzyl phthalate (BBP), and a dispersant of fish oil were added to form a powder slurry. The powder slurry was mixed by ball milling for an additional 24 hours to yield the desired slip rheology. Tape casting was performed using a laboratory tape casting machine. The thickness of hydrogen-electrode green tapes was controlled to be about 1 mm after drying at 37.8° C. for 4 hours.

Green tapes of electrolyte were prepared similarly without adding NiO and by controlling the thickness to about 0.12 mm (for a 22 μm thick BZCYYb electrolyte after sintering) or about 0.08 mm (for a 16 μm thick BZCYYb electrolyte after sintering) after drying. Three pieces of hydrogen-electrode green tapes and one piece of electrolyte green tape were laminated by a hot press at 70° C. under 4 tons (e.g., 4000 kg) for 5 hours. Laminated green tapes were punched and pre-sintered at 920° C. for 3 hours to remove the organics. The co-sintering of hydrogen electrode-electrolyte bi-layer was conducted at T₁=1400° C. for 5 hours (heating rate: 1° C. min⁻¹ to 1000° C. and 2° C. min⁻¹ to 1400° C.). The co-sintered hydrogen electrode-electrolyte bi-layer was then allowed to cool.

A surface treatment including concentrated nitric acid was applied to the surface of the electrolyte of the co-sintered hydrogen electrode-electrolyte bi-layer for a period of time within a range of from 1 minutes to 15 minutes (e.g., 1 minute, 2 minutes, 5 minutes, 10 minutes, and 15 minutes) and then washed with deionized water. For comparison purposes, a control co-sintered hydrogen electrode-electrolyte bi-layer was not exposed to the surface treatment.

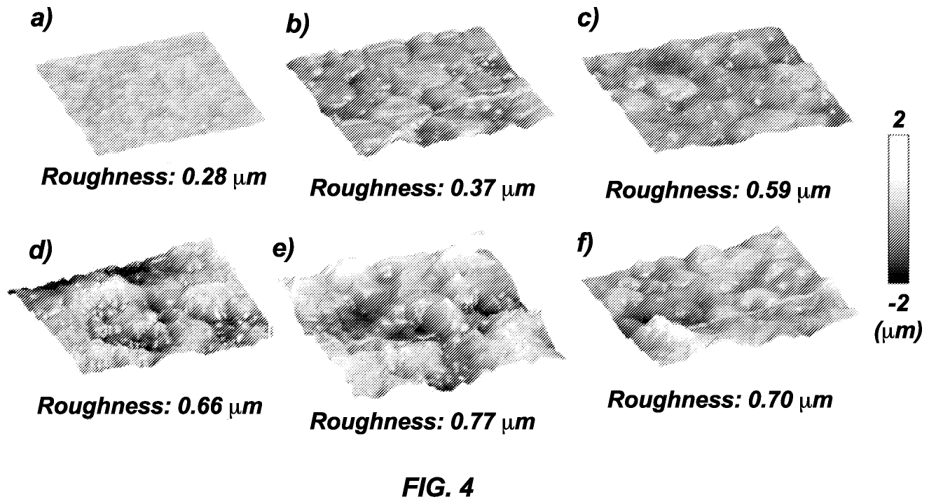

Surface roughness of the electrolyte of the co-sintered hydrogen electrode-electrolyte bi-layer was inspected using a Dimension FASTSCAN® atomic force microscope (AFM) from Bruker using a tapping mode. Referring to FIG. 4, the AFM scan of an untreated electrolyte surface is shown at a), the AFM scan of an electrolyte surface treated for 1 minute is shown at b), the AFM scan of an electrolyte surface treated for 2 minutes is shown at c), the AFM scan of an electrolyte surface treated for 5 minutes is shown at d), the AFM scan of an electrolyte surface treated for 10 minutes is shown at e), and the AFM scan of an electrolyte surface treated for 15 minutes is shown at f). Table 1 includes the surface roughness measured by conventional techniques for the electrochemical cells (e.g., untreated, treated for 1 minute, treated for 2 minutes, treated for 5 minutes, treated for 10 minutes, treated for 15 minutes).

TABLE 1
Surface Roughness of the Electrolyte

| | | Treatment Time (min) | | | | |
|---|---|---|---|---|---|---|
| | Untreated | 1 | 2 | 5 | 10 | 15 |
| Surface Roughness | 0.28 | 0.37 | 0.59 | 0.66 | 0.77 | 0.70 |
| (μm) | | | | | | |

Without being bound by any theory, it is believed that the concentrated nitric acid reacts with an upper portion of the electrolyte layer to form nitrate. After the treatment, the electrolyte surface is cleaned by deionized water to remove the residue including nitrate and extra nitric acid. The etching of the electrolyte surface by the nitric acid removes the well-annealed surface and increases the surface roughness of the electrolyte.

To fabricate full electrochemical cells, slurries of the oxygen electrode materials described in Example 1 were prepared by mixing the described oxygen electrode powders with ethanol and a texanol-based binder by ball milling. The slurries of the oxygen electrode materials were individually brush-painted on a surface of an electrolyte of a respective co-sintered hydrogen electrode-electrolyte bi-layer. For the 3D PNC73 mesh electrode, the heat-treated mesh was bonded to a surface of an electrolyte of a respective co-sintered hydrogen electrode-electrolyte layer using a thin layer of brush-painted PNC73 slurry. The surface area of the oxygen electrodes was controlled to be about 0.178 cm². The brush-painted cells were sintered at T₂=1000° C. for 4 hours (heating rate: 3° C. min⁻¹) and then allowed to cool.

### Example 3

### Cell Testing Assembly

Electrochemical cells including NiO and BZCYYb hydrogen electrodes and PNC55 oxygen electrodes as described in Examples 1 and 2 were sealed in a reactor using Aremco Ceramabond™ 552 adhesive with the oxygen electrode side of the electrochemical cells exposed. Silver mesh was used as a current collector with attached silver wires as leads. After assembly, the electrochemical cells were heated to 600° C. at a heating rate of 1° C. min⁻¹. When a temperature of 600° C. was reached, H₂ gas was fed into the hydrogen electrodes at a flow rate of 20 mL min⁻¹ to reduce the NiO of the hydrogen electrodes to metallic Ni. After reducing the NiO to metallic Ni, a bubbler was connected to hydrolyze H₂ with 3 wt % steam.

### Example 4

### Electrochemical Impedance Spectroscopy (EIS) Measurements

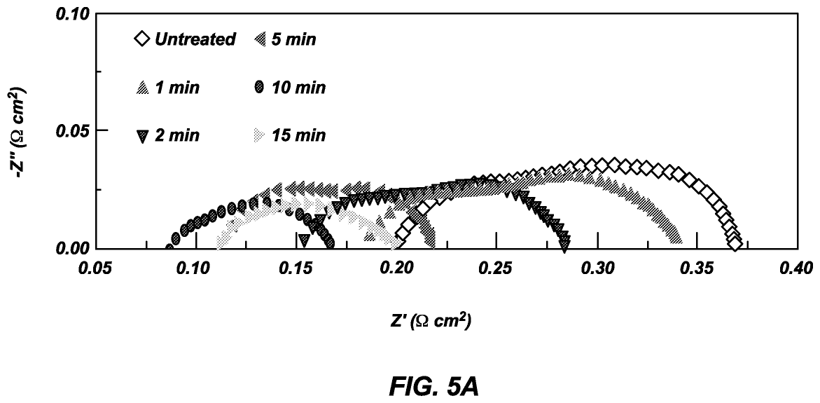

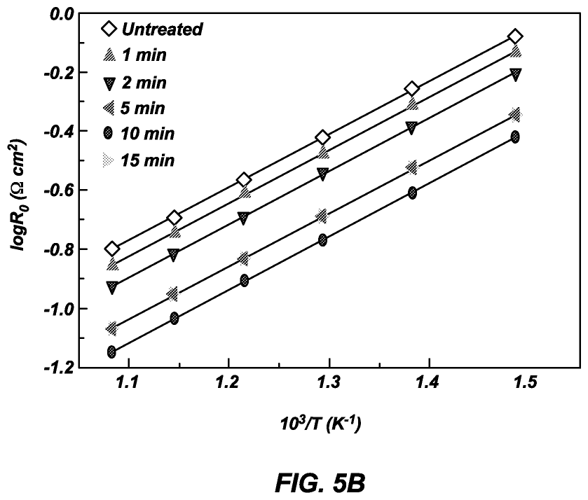

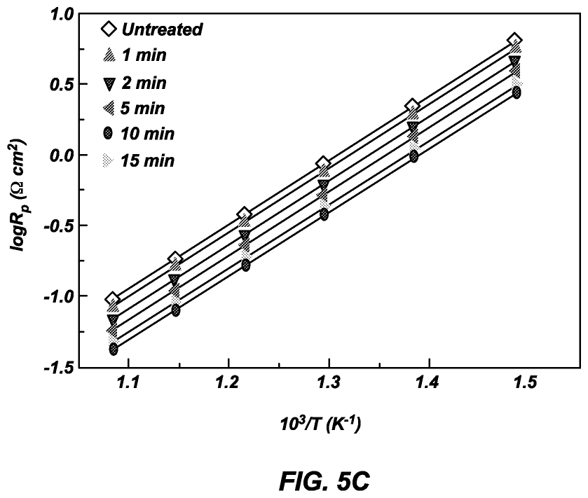

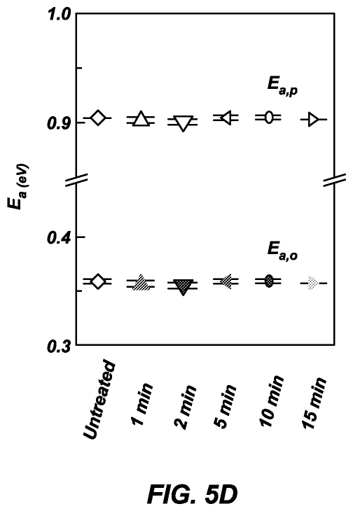

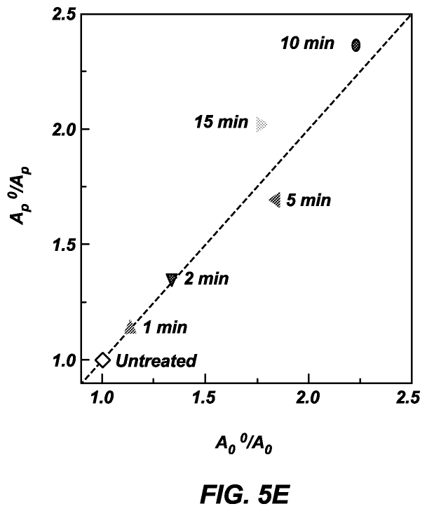

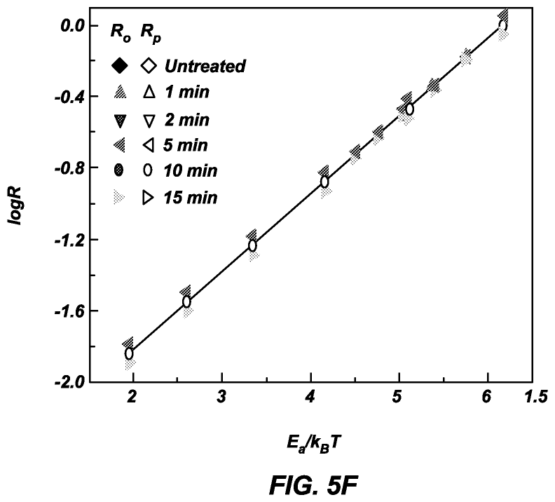

EIS measurements were conducted under open-circuit voltage (OCV) at temperatures between 400° C. and 650° C. for electrochemical cells including Ni-BZCYYb hydrogen electrodes and PNC55 oxygen electrodes described in Examples 1-3 operating as fuel cells with feedstocks of H₂ and 3 wt % H₂O for the hydrogen electrodes and O₂ for the oxygen electrodes. FIG. 5A illustrates a Cole-Cole plot obtained from the EIS measurements, where the x-axis is Z′ and the y-axis is-Z″, where Z′ and Z″ are the real and imaginary parts of the complex impedance, respectively. As shown by the Cole-Cole plot of FIG. 5A, the surface treatment described in Example 2 applied for a time up to 10 minutes lowered both ohmic resistance Rₒ (shown by the left intercept of the EIS curve with the x-axis) and polarization resistance Rₚ (shown by the right intercept of the EIS curve with the x-axis minus Rₒ). Both Rₒ and Rₚ reached their corresponding minimum value in the electrochemical cell treated for 10 minutes, which correlates with the largest surface roughness of the electrolyte and highest interfacial strength between the electrolyte and the oxygen electrode. The decreased Rₚ indicated an increase in activity of a triple-phase boundary between the electrolyte, oxygen electrode, and the O₂ gas feedstock of the oxygen electrode. Rₒ and Rₚ are assumed to follow an Arrhenius-type temperature dependence

$${R}_{o} = {A}_{o} exp ( - \frac{{E}_{a , o}}{{k}_{B} T} ) \qquad ( 1 )$$

$${R}_{p} = {A}_{p} exp ( - \frac{{E}_{a , p}}{{k}_{B} T} ) \qquad ( 2 )$$

Where A is the respective pre-exponent term, Eₐ is the activation energy, the subscripts o and p denote that for Rₒ and Rₚ, respectively, k_{B} is the Boltzmann constant, and T is the absolute temperature. The plot of log Rₒ vs. 1/T illustrated in FIG. 5B and the plot of log Rₚ vs. 1/T illustrated in FIG. 5C show the curves of the electrochemical cells treated with nitric acid for different times were parallel to each other, indicating that the treatment does not affect the activation energy of Rₒ and Rₚ. An activation energy of E_{a,o}=0.358±0.001 eV for Rₒ and E_{a,p}=0.903±0.003 eV for Rₚ were deduced for the analyzed electrochemical cells, as shown in the plot of calculated activation energy shown at FIG. 5D. Instead, the treatment time modified Rₒ and Rₚ by changing the pre-exponential factor Aₒ and Aₚ. This was distinct from the conventional practice of enhancing kinetics by lowering the activation energy.

The enhancement factor for 1/Aₒ and 1/Aₚ in the treated electrochemical cells over the pre-exponent term 1/Aₒ⁰ and 1/Aₚ⁰ in the untreated electrochemical cell was calculated and plotted in an Aₒ/Aₒ vs. Aₚ⁰/Aₚ plot shown in FIG. 5E. A dimensionless reduced temperature k_{B}T/Eₐ and a dimensionless relative “resistance” R were combined into a single curve in the Arrhenius plot shown in FIG. 5F. The EIS measurements suggest a single mechanism was responsible for the simultaneously lowered Rₒ and Rₚ, which were lowered by lowering their pre-exponential factor without changing the mechanisms of electrode reactions and proton conduction (inferred by unchanged activation energy). Accordingly, the increased effective contact area between the oxygen electrode and electrolyte and resulting improved interfacial bonding were determined to be responsible for the lowered Rₒ and Rₚ.

### Example 5

### Electrochemical PCFC and PCEC Testing

Electrochemical tests of the electrochemical cells including Ni-BZCYYb hydrogen electrodes and PNC55 oxygen electrodes described in Examples 1-3 operating as fuel cells (e.g., protonic ceramic fuel cells (PCFCs)) and operating as electrolysis cells (e.g., protonic ceramic electrolysis cells (PCECs)) were conducted. Current density-voltage curves and current density-power density curves of the electrochemical cells operating as fuel cells were measured using a Solartron 1400 and a Solartron 1470 electrochemical working station after a stable OCV was observed at the set temperature. When operated as fuel cells, the feedstocks were H₂ and 3 wt % steam for the hydrogen electrode and pure O₂ for the oxygen electrode. Electrochemical data for the electrochemical cells operating as fuel cells was collected for a voltage range from OCV to 0.2 V at the set temperature. Continuous operation as a fuel cell was conducted under a constant applied voltage of 0.75 V at 600° C. for up to 200 hours. After tests for operation as a fuel cell were completed, the electrochemical cells were switched to operate as electrolysis cells. When operated as electrolysis cells, the feedstocks were pure H₂ for the hydrogen electrode and O₂ and 30 wt % H₂O for the oxygen electrode. Electrochemical tests were conducted after a stable OCV was observed at the set temperature, for a voltage range from 1.5 V to OCV. Continuous operation as an electrolysis cell was conducted under a constant applied voltage of 1.4 V at 600° C. for up to 200 hours.

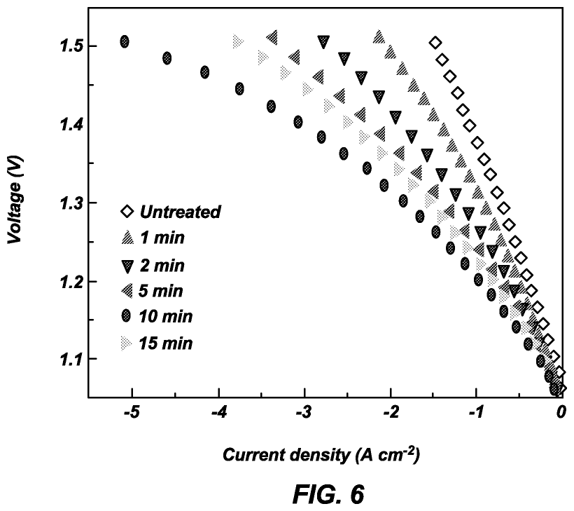

FIG. 6 is a current density vs. voltage plot (e.g., polarization curve) of the electrochemical cells operated as electrolysis cells under a constant applied voltage of 1.4 V at 600° C. When a voltage larger than OCV (e.g., 1.04 V at 600° C.) was applied, the absolute value of the current density j (defined as being negative for an electrolysis cell and positive for a fuel cell) was used to evaluate the electrochemical cell performance. As shown in FIG. 6, under the same applied voltage, a larger |j| was achieved in the treated electrochemical cells than in the untreated electrochemical cell. A 2.8-fold increment over the untreated electrochemical cell was observed in the |j| of the electrochemical cell treated for 10 minutes under 1.4 V at 600° C. (|j|=3.07 A cm⁻²) during operation as an electrolysis cell.

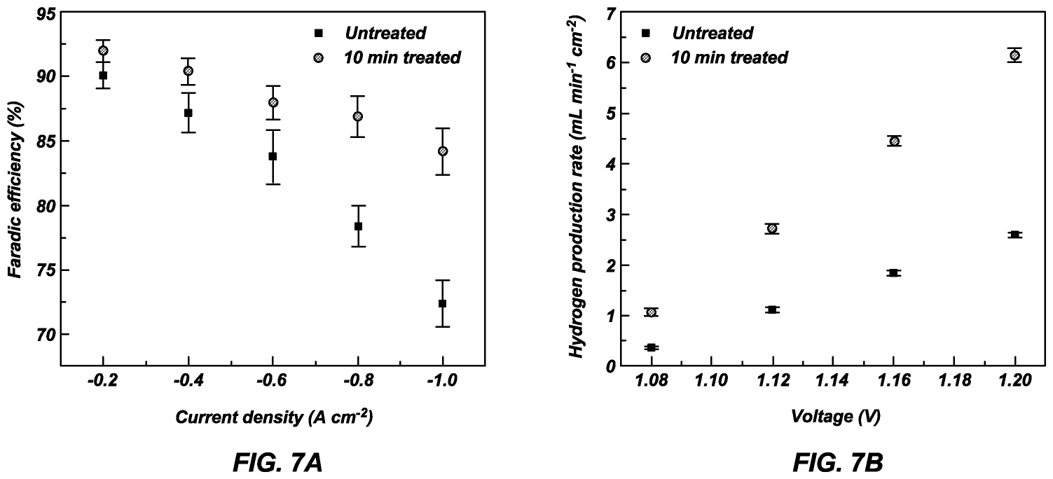

FIG. 7A is a current density vs. Faradic efficiency plot for the untreated electrochemical cell and the electrochemical cell treated with nitric acid for 10 minutes operated as electrolysis cells. FIG. 7B is a voltage vs. hydrogen production rate plot for the untreated electrochemical cell and the electrochemical cell treated with nitric acid for 10 minutes operated as electrolysis cells. As shown in FIGS. 7A and 7B, the electrochemical cell treated for 10 minutes demonstrated a higher Faradic efficiency and a higher hydrogen production rate than the untreated electrochemical cell.

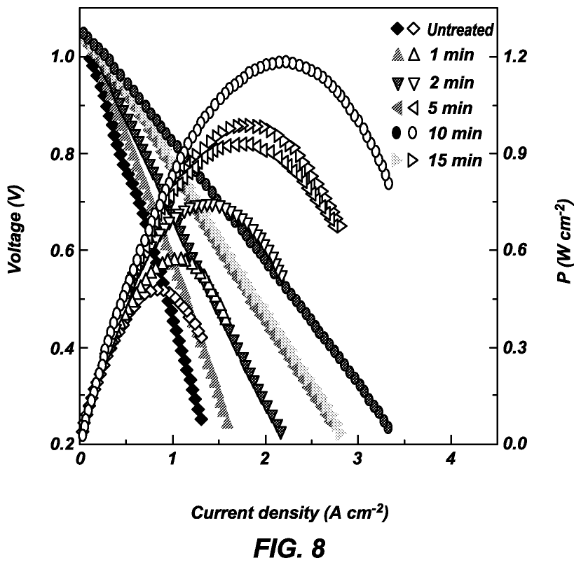

FIG. 8 is a current density vs. voltage plot (e.g., polarization curve) and a current density vs. power density plot (e.g., power density curve) of the electrochemical cells operated as fuel cells under a constant applied voltage of 0.75 V at 600° C. As shown in FIG. 8, the current density was higher in the treated electrochemical cells than in the untreated electrochemical cell at the same voltage. A 2.5-fold increment over the untreated electrochemical cell was observed in the peak power density Pₘₐₓ of the electrochemical cell treated for 10 minutes (Pₘₐₓ=1.18 W cm⁻²) during operation as a fuel cell.

### Example 6

### Degradation Testing

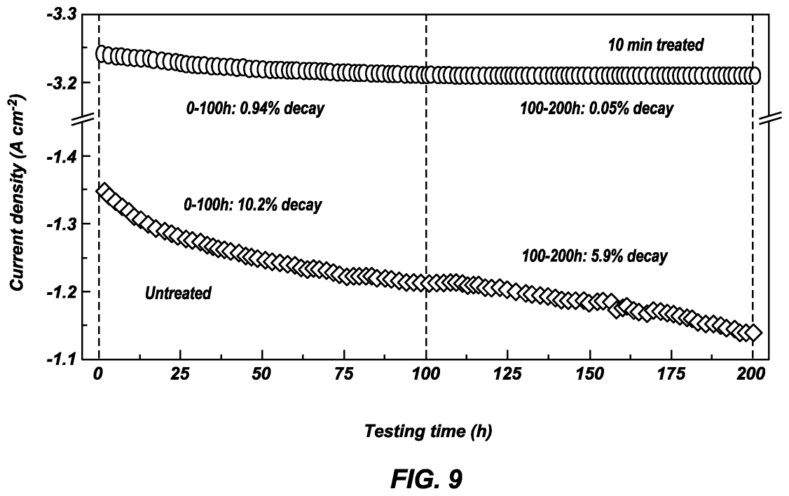

Accelerated degradation tests were conducted under high-current-density operation of the electrochemical cells including Ni-BZCYYb hydrogen electrodes and PNC55 oxygen electrodes described in Examples 1-3 as electrolysis cells (e.g., PCECs). High-current-density PCEC operations are known to cause severe stability issues due to the harsh thermomechanical and electrochemical conditions. FIG. 9 is a testing time vs. current density plot (e.g., current density curve) of the untreated electrochemical cell and the electrochemical cell treated with nitric acid for 10 minutes operated as PCECs under a constant applied voltage of 1.4 V at 600° C. The electrochemical cell treated for 10 minutes exhibited a high initial j of about −3.24 A cm⁻² and was stable for over 200 hours of continuous operation. As shown in FIG. 9, |j| of the electrochemical cell treated for 10 minutes exhibited a 0.94% decay between 0 hours and 100 hours of operation and a 0.05% decay between 100 hours and 200 hours of operation. In comparison, the untreated electrochemical cell exhibited a smaller initial j of about −1.35 A cm⁻². The untreated electrochemical cell additionally exhibited fast degradation, with a 10.2% decay in |j| between 0 hours and 100 hours of operation and a 5.9% decay between 100 hours and 200 hours of operation. Post-testing analysis of the untreated electrochemical cell revealed severe delamination of the oxygen electrode after electrochemical cycling and a change in the fracture mode of the BZCYYb electrolyte layer from the intragranular-cracking behavior observed in an untested electrochemical cell. In comparison, post-testing analysis of the electrochemical cell treated with nitric acid for 10 minutes revealed no observable oxygen electrode delamination and the BZCYYb electrolyte layer retained the intragranular cracking behavior after 200 hours of operation.

### Example 7

### Peeling Strength

A peeling strength of the oxygen electrode-electrolyte interface of the electrochemical cells including Ni-BZCYYb hydrogen electrodes and PNC55 oxygen electrodes described in Examples 1-3 was measured. To measure the peeling strength of the oxygen electrode-electrolyte interface, double-sided tape was attached to both sides of electrochemical cells with a rectangular shape having a length of 1.18 inch and a width of 1 inch. The hydrogen electrode side of the electrochemical cells was attached to a testing bed with the oxygen electrode facing up and tape was attached to the double-sided tape on the oxygen electrode side. The oxygen electrode was then peeled off from the electrolyte while the force was recorded and converted to peeling strength. Table 2 includes the peeling strength observed for each of the electrochemical cells (e.g., untreated, treated for 1 minute, treated for 2 minutes, treated for 5 minutes, treated for 10 minutes, treated for 15 minutes).

TABLE 2
Peeling Strength of the Oxygen Electrode-Electrolyte Interface

| | | Treatment Time (min) | | | | |
|---|---|---|---|---|---|---|
| | Untreated | 1 | 2 | 5 | 10 | 15 |
| Peeling Strength | 18.6 | 18.8 | 19.9 | 22 | 23.5 | 20.2 |
| (N) | | | | | | |

### Example 8

### Oxygen Electrode Composition Testing

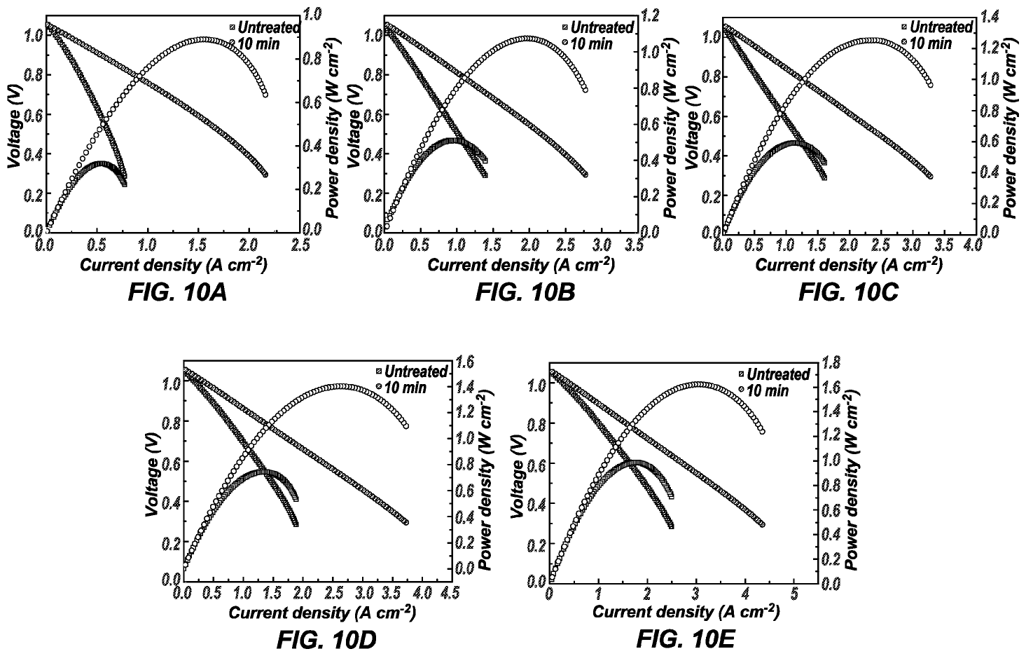

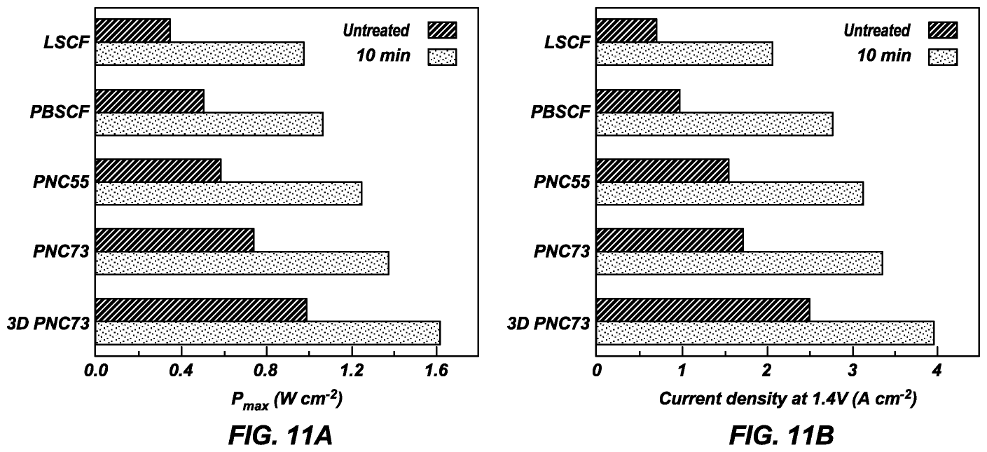

The electrochemical cells having a BZCYYb electrolyte exhibiting a thickness of about 16 μm and oxygen electrodes formed of one of LSCF, PBSCF, PNC55, PNC73, or 3D PNC73 mesh described in Examples 1-3 were operated as fuel cells at 600° C. using CH₄ and C₂H₆ with 3 wt % steam at a flow rate of 20 mL min⁻¹ as the feedstock for the hydrogen electrodes and pure O₂ at a flow rate of 60 mL min⁻¹ as the feedstock for the oxygen electrodes. FIGS. 10A-10E are current density vs. voltage and power density plots for each of an untreated electrochemical cell and an electrochemical cell treated for 10 minutes made up of the 16 μm BZCYYb electrolyte and one of an LSCF oxygen electrode (FIG. 10A), a PBSCF oxygen electrode (FIG. 10B), a PNC55 oxygen electrode (FIG. 10C), a PNC73 oxygen electrode (FIG. 10D), and a 3D PNC73 mesh oxygen electrode (FIG. 10E). FIG. 11A is a graphical comparison of peak power density Pₘₐₓ of untreated electrochemical cells and 10 minute treated electrochemical cells made up of the 16 μm BZCYYb electrolyte and one of the LSCF, PBSCF, PNC55, PNC73, or 3D PNC73 mesh oxygen electrodes operated as fuel cells with the conditions described above. FIG. 11B is a graphical comparison of current density j of untreated electrochemical cells and 10 minute treated electrochemical cells made up of the 16 μm BZCYYb electrolyte and one of the LSCF, PBSCF, PNC55, PNC73, or 3D PNC73 mesh oxygen electrodes operated as fuel cells with the conditions described above. The plots shown in FIGS. 10A-10E and the graphical comparisons shown in FIGS. 11A and 11B demonstrated an increase in cell performance for all electrochemical cell compositions treated with the electrolyte surface treatment for 10 minutes over the untreated electrochemical cells.

Table 3 includes the peak power density for the untreated electrochemical cells (denoted as “Un-”) and the electrochemical cells treated for 10 minutes (denoted as “Tr-”) including a 16 μm thick BZCYYb electrolyte and different oxygen electrode materials shown in Table 3. “/” denotes an untested combination of temperature and electrochemical cell.

TABLE 3
Peak Power Density with Different Oxygen Electrode

| Operation | Peak Power Density (mW cm⁻²) | | | | | | | | | |
|---|---|---|---|---|---|---|---|---|---|---|
| temperature | LSCF | | PBSCF | | PNC55 | | PNC73 | | 3D PNC73 | |
| (° C.) | Un- | Tr- | Un- | Tr- | Un- | Tr- | Un- | Tr- | Un- | Tr- |
| 600 | 350 | 980 | 510 | 1071 | 592 | 1250 | 747 | 1379 | 983 | 1620 |
| 550 | 165 | 721 | 264 | 801 | 324 | 912 | 458 | 982 | 610 | 1252 |
| 500 | 76 | 447 | 134 | 517 | 162 | 634 | 276 | 691 | 389 | 901 |
| 450 | — | 254 | — | 332 | — | 400 | 128 | 456 | 176 | 651 |
| 400 | — | 137 | — | 180 | — | 221 | — | 282 | 89 | 474 |
| 350 | — | 77 | — | 90 | — | 120 | — | 150 | — | 288 |

“—” indicates not measured

### Example 9

### Leakage Testing

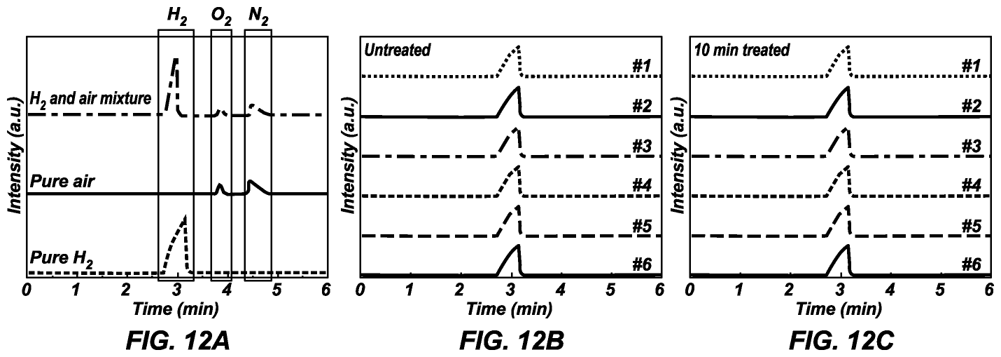

Leakage tests of untreated and 10 minute treated electrochemical cells made up of 16 μm BZCYYb electrolyte and PNC55 oxygen electrode operated as fuel cells at 600° C. using pure H₂ at a flow rate of 20 mL min⁻¹ as the feedstock for the hydrogen electrodes and air at a flow rate of 60 mL min⁻¹ as the feedstock for the oxygen electrode were conducted. OCV was monitored continuously for 205 hours with the H₂ in the hydrogen electrodes and the air in the oxygen electrodes. Gas chromatography was conducted to detect the gas condition in the hydrogen electrode every 48 hours and at the end of the test at 205 hours. As shown in FIG. 12A, gas chromatography for three reference gases (pure H₂, pure air, and H₂ and air mixture) was conducted. A H₂ detection peak was observed at 2.9 minutes, an O₂ detection peak was observed at 3.9 minutes, and an N₂ detection peak was observed at 4.7 minutes. As shown in FIGS. 12B and 12C, gas chromatography for the untreated electrochemical cell (FIG. 12B) and for the electrochemical cell treated for 10 minutes (FIG. 12C) was conducted and an H₂ detection peak was observed at 2.9 minutes and no O₂ or N₂ peaks were observed, indicating that the electrochemical cells were gas-tight with dense electrolyte.

Additional non-limiting example embodiments of the disclosure are set forth below.

Embodiment 1: A method of improving an interface between an electrode and an electrolyte of an electrochemical cell, the method comprising: forming an electrolyte material on an electrode of an electrochemical cell, the electrolyte material comprising a perovskite material; and exposing the electrolyte material to one or more of an acid solution, a plasma, thermal shock, and gamma radiation to increase a surface roughness of the electrolyte material.

Embodiment 2: The method of Embodiment 1, wherein exposing the electrolyte material to one or more of an acid solution, a plasma, thermal shock, and gamma radiation comprises exposing the electrolyte material to an aqueous acid solution.

Embodiment 3: The method of Embodiment 1 or Embodiment 2, wherein exposing the electrolyte material to one or more of an acid solution, a plasma, thermal shock, and gamma radiation comprises exposing the electrolyte to a solution comprising nitric acid, hydrochloric acid, sulfuric acid, phosphoric acid, or a combination thereof.

Embodiment 4: The method of any of Embodiments 1 through 3 wherein exposing the electrolyte material to one or more of an acid solution, a plasma, thermal shock, and gamma radiation comprises exposing the electrolyte to an acid solution comprising nitric acid.

Embodiment 5: The method of any of Embodiments 1 through 4, wherein exposing the electrolyte material to one or more of an acid solution, a plasma, thermal shock, and gamma radiation comprises exposing the electrolyte to an acid solution comprising a concentration of acid within a range of from about 60 wt % to about 80 wt %.

Embodiment 6: The method of any of Embodiments 1 through 5, wherein exposing the electrolyte material to one or more of an acid solution, a plasma, thermal shock, and gamma radiation comprises exposing the electrolyte material to one or more of an acid solution, a plasma, thermal shock, and gamma radiation for a period of time within a range of from about 5 minutes to about 15 minutes.

Embodiment 7: The method of any of Embodiments 1 through 6, wherein forming an electrolyte material on an electrode of an electrochemical cell comprises forming an electrolyte material on an electrode comprising a nickel/perovskite cermet.

Embodiment 8: The method of any of Embodiments 1 through 7, wherein exposing the electrolyte material to one or more of an acid solution, a plasma, thermal shock, and gamma radiation to increase a surface roughness of the electrolyte material comprises increasing the surface roughness of the electrolyte to a roughness within a range of from about 0.5 μm to about 1 μm.

Embodiment 9: The method of any of Embodiments 1 through 8, further comprising heating the electrolyte material on the electrode to a temperature greater than about 1300° C. for a period of time greater than about 3 hours.

Embodiment 10: A method of forming an electrochemical cell, the method comprising: forming an electrolyte material on a first electrode of an electrochemical cell, the electrolyte material comprising a perovskite material; exposing the electrolyte material to at least one acid solution to increase surface roughness of the electrolyte material; and after exposing the electrolyte material to the at least one acid solution, forming a second electrode on the electrolyte material.

Embodiment 11: The method of Embodiment 10, wherein exposing the electrolyte material to at least one acid solution comprises exposing the electrolyte material to a nitric acid solution comprising a concentration of nitric acid of about 70 wt %.

Embodiment 12: The method of Embodiment 10 or Embodiment 11, wherein forming a second electrode on the electrolyte material comprises forming a second electrode comprising at least one perovskite material on the electrolyte material.

Embodiment 13: The method of any of Embodiments 10 through 12, wherein forming an electrolyte material on a first electrode comprises forming an electrolyte material exhibiting an ionic conductivity greater than or equal to about 10⁻² S/cm at one or more temperatures within a range of from about 150° C. to about 650° C. on the first electrode.

Embodiment 14: The method of any of Embodiments 10 through 13, wherein exposing the electrolyte material to at least one acid solution comprises removing a portion of the electrolyte material adjacent an exposed surface of the electrolyte material opposite the first electrode.

Embodiment 15: The method of any of Embodiments 10 through 14, further comprising heating the first electrode, the electrolyte, and the second electrode to diffusion bond the second electrode to the electrolyte material.

Embodiment 16: An electrochemical cell comprising: a first electrode; a second electrode; and a proton-conducting membrane between the first electrode and the second electrode, the proton-conducting membrane comprising a perovskite material, wherein an interface between the proton-conducting membrane and the second electrode exhibits a peeling strength within a range of from about 17 N to about 40 N.

Embodiment 17: The electrochemical cell of Embodiment 16, wherein the perovskite material exhibits an ionic conductivity greater than or equal to about 10⁻² S/cm at one or more temperatures within a range of from about 150° C. to about 650° C.

Embodiment 18: The electrochemical cell of Embodiment 16 or Embodiment 17, wherein: the first electrode comprises nickel and a yttrium- and ytterbium-doped barium-zirconate-cerate (BZCYYb); and the electrolyte material comprises BZCYYb.

Embodiment 19: The electrochemical cell of any of Embodiments 16 through 18, wherein the second electrode comprises PrNi_{0.5}Co_{0.5}O_{3-δ} (PNC55).

Embodiment 20: A system for H₂ gas production and electricity generation, comprising: at least one steam source, at least one electrochemical apparatus in fluid communication with the at least one steam source, and a power source electrically connected to the at least one electrochemical apparatus, the at least one electrochemical apparatus comprising one or more electrochemical cells of any of Embodiments 16 through 19.

While the disclosure is susceptible to various modifications and alternative forms, specific embodiments have been shown by way of example in the drawings and have been described in detail herein. However, the disclosure is not intended to be limited to the particular forms disclosed. Rather, the disclosure encompasses all modifications, equivalents, and alternatives falling within the scope of the disclosure as defined by the following appended claims and their legal equivalents.

1. A method of improving an interface between an electrode and an electrolyte of an electrochemical cell, the method comprising:
forming an electrolyte material on an electrode of an electrochemical cell, the electrolyte material comprising a perovskite material; and
exposing the electrolyte material to one or more of an acid solution, a plasma, thermal shock, and gamma radiation to increase a surface roughness of the electrolyte material.

2. The method of claim 1, wherein exposing the electrolyte material to one or more of an acid solution, a plasma, thermal shock, and gamma radiation comprises exposing the electrolyte material to an aqueous acid solution.

3. The method of claim 1, wherein exposing the electrolyte material to one or more of an acid solution, a plasma, thermal shock, and gamma radiation comprises exposing the electrolyte to a solution comprising nitric acid, hydrochloric acid, sulfuric acid, phosphoric acid, or a combination thereof.

4. The method of claim 1, wherein exposing the electrolyte material to one or more of an acid solution, a plasma, thermal shock, and gamma radiation comprises exposing the electrolyte to an acid solution comprising nitric acid.

5. The method of claim 1, wherein exposing the electrolyte material to one or more of an acid solution, a plasma, thermal shock, and gamma radiation comprises exposing the electrolyte to an acid solution comprising a concentration of acid within a range of from about 60 wt % to about 80 wt %.

6. The method of claim 1, wherein exposing the electrolyte material to one or more of an acid solution, a plasma, thermal shock, and gamma radiation comprises exposing the electrolyte material to one or more of an acid solution, a plasma, thermal shock, and gamma radiation for a period of time within a range of from about 5 minutes to about 15 minutes.

7. The method of claim 1, wherein forming an electrolyte material on an electrode of an electrochemical cell comprises forming an electrolyte material on an electrode comprising a nickel/perovskite cermet.

8. The method of claim 1, wherein exposing the electrolyte material to one or more of an acid solution, a plasma, thermal shock, and gamma radiation to increase a surface roughness of the electrolyte material comprises increasing the surface roughness of the electrolyte to a roughness within a range of from about 0.5 μm to about 1 μm.

9. The method of claim 1, further comprising, before exposing the electrolyte material to one or more of an acid solution, a plasma, thermal shock, and gamma radiation, heating the electrolyte material on the electrode to a temperature greater than about 1300° C. for a period of time greater than about 3 hours.

10. A method of forming an electrochemical cell, the method comprising:
forming an electrolyte material on a first electrode of an electrochemical cell, the electrolyte material comprising a perovskite material;
exposing the electrolyte material to at least one acid solution to increase surface roughness of the electrolyte material, and
after exposing the electrolyte material to the at least one acid solution, forming a second electrode on the electrolyte material.

11. The method of claim 10, wherein exposing the electrolyte material to at least one acid solution comprises exposing the electrolyte material to a nitric acid solution comprising a concentration of nitric acid of about 70 wt %.

12. The method of claim 10, wherein forming a second electrode on the electrolyte material comprises forming a second electrode comprising at least one perovskite material on the electrolyte material.

13. The method of claim 10, wherein forming an electrolyte material on a first electrode comprises forming an electrolyte material exhibiting an ionic conductivity greater than or equal to about 10⁻² S/cm at one or more temperatures within a range of from about 150° C. to about 650° C. on the first electrode.

14. The method of claim 10, wherein exposing the electrolyte material to at least one acid solution comprises removing a portion of the electrolyte material adjacent to an exposed surface of the electrolyte material opposite the first electrode.

15. The method of claim 10, further comprising heating the first electrode, the electrolyte material, and the second electrode to diffusion bond the second electrode to the electrolyte material.

16. An electrochemical cell comprising:
a first electrode;
a second electrode; and
a proton-conducting membrane between the first electrode and the second electrode, the proton-conducting membrane comprising a perovskite material,
wherein an interface between the proton-conducting membrane and the second electrode exhibits a peeling strength within a range of from about 17 N to about 40 N.

17. The electrochemical cell of claim 16, wherein the perovskite material exhibits an ionic conductivity greater than or equal to about 10⁻² S/cm at one or more temperatures within a range of from about 150° C. to about 650° C.

18. The electrochemical cell of claim 16, wherein:
the first electrode comprises nickel and a yttrium- and ytterbium-doped barium-zirconate-cerate (BZCYYb); and
the proton-conducting membrane comprises BZCYYb.

19. The electrochemical cell of claim 16, wherein the second electrode comprises PrNi_{0.5}Co_{0.5}O_{3-δ} (PNC55).

20. A system for H₂ gas production and electricity generation, comprising:
at least one steam source, at least one electrochemical apparatus in fluid communication with the at least one steam source, and a power source electrically connected to the at least one electrochemical apparatus, the at least one electrochemical apparatus comprising one or more electrochemical cells comprising:
a first electrode;
a second electrode; and
a proton-conducting membrane between the first electrode and the second electrode, the proton-conducting membrane comprising a perovskite material,
wherein an interface between the proton-conducting membrane and the second electrode exhibits a peeling strength within a range of from about 17 N to about 40 N.
